(19) United States
(12) Patent Application Publication
(10) Pub. No.: US 2008/0263640 A1
(43) Pub. Date: Oct. 23, 2008

(54) Translation Engine for Computer Authorizations Between Active Directory and Mainframe System

(75) Inventor: Mark D. Brown, St. Paul, MN (US)

Correspondence Address: SHUMAKER & SIEFFERT, P. A., 1625 RADIO DRIVE, SUITE 300, WOODBURY, MN, 55125, US

(73) Assignee: REDPHONE SECURITY, INC., St. Paul, MN (US)

(21) Appl. No.: 11/667,738

(22) PCT Filed: Dec. 7, 2005
(86) PCT No.: PCT/US05/44077

§ 371 Date: May 7, 2008

Related U.S. Application Data
(60) Provisional application No. 60/638,617, filed on Dec. 23, 2004.

(51) Int. Cl. G06F 21/20

(52) U.S. Cl. 726/5

(57) ABSTRACT

The invention provides a method and system of implementing a high performance “non-RACF external security-manager product,” which maintains and translates a merged single source of authorizations to both mainframe and Microsoft Windows Active Directory (AD) systems. In one embodiment, a method comprises generating at a server computer access information for a mainframe computer indicative of mainframe authorization for a set of users, receiving from the mainframe computer information indicative of an authorization request, the information indicative of the authorization request identifying a user trying to access the mainframe computer, and sending at least a portion of the access information from the server computer to the mainframe computer, the portion of the access information including mainframe access information for the user.

The invention provides a method and system of implementing a high performance “non-RACF external security-manager product”¹ which maintains and translates a merged single source of authorizations to both mainframe and Microsoft Windows Active Directory (AD) systems. The merged set of authorizations data appears to be both AD “groups” and mainframe “groups” (and similar access conditions) at the same time, for both users and security administrators. ¹ OS/390 Security Server External Security Interface (RACROUTE) Macro Reference, p. 387. RACF stands for Resource Access Control Facility.

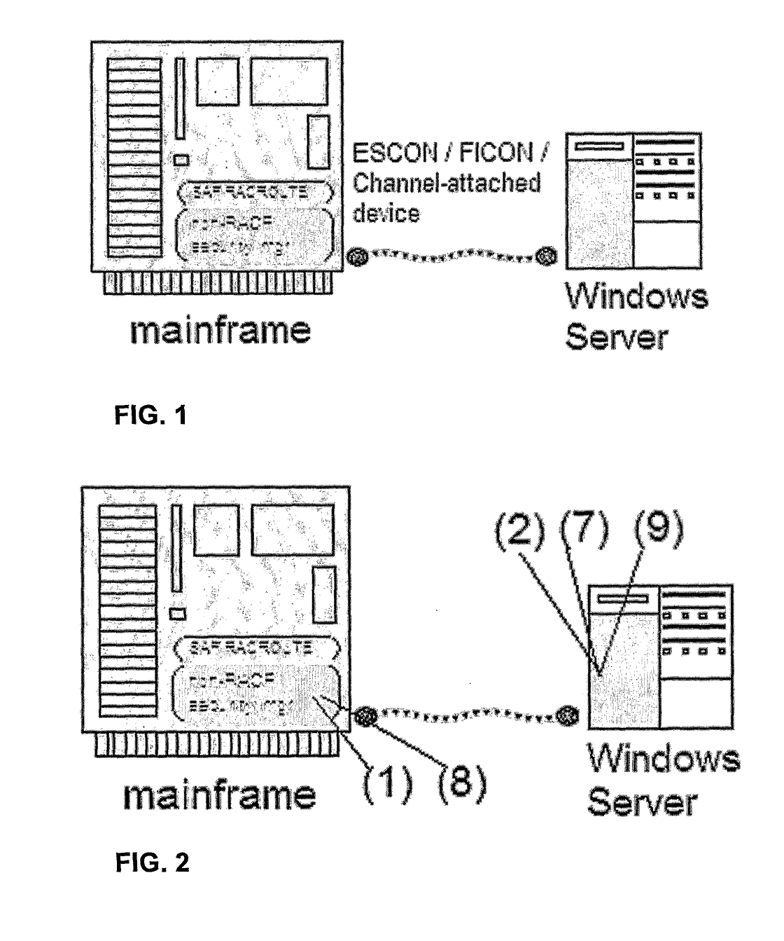

FIG. 1 illustrates one embodiment of the invention.

The invention may use AD's Kerberos-enabled enterprise (not local) groups and users together with mainframe-style conditional resource authorizations to determine the answers to mainframe access requests while achieving an overall reduction in mainframe authorization processing computations.

Some of the earliest thought leadership by IBM on the topic of distributed architecture² developed from the mid 1970's effort to create the IBM Systems Network Architecture (SNA) networking protocol improvement dubbed Advanced Peer-to-Peer Networking (APPN) which was a part of the next generation SNA protocol dubbed SNA “LU6.2”. APPN made developments relevant to this invention further in 1982, 1988, etc., as the Distributed Data Management (DDM) Architecture. The DDM design includes the requirement of a local security manager on every system. This design assumption was reiterated in 1992 by its lead architect Demers: ² the story is well-told in Demers, et al, IBM Systems Journal v31, n3, 1992; pp 460-2 in “Inside IBM's Distributed Data Management Architecture.”
Each type of system has its own security facilities, each with its own model of security and its own programming interfaces to that model. Among these interfaces are those that allow a user to be authorized to the system as a whole, and those that allow authorizations to specific resources [i.e., individually named files, programs, devices, databases, and also groups of such “resources”] to be granted, revoked, and shared with other users.

Examples of security facilities are the Resource Access Control Facility (RACF™) on MVS/ESA and VM/ESA, the security manager of OS/400, and the GRANT/REVOKE functions of relational database managers.
Validation of authorizations must also be performed when a remote user attempts to use a DDM architecture server or one of its resources. When an SNA LU 6.2 conversation [roughly equivalent to a TCP/IP network connection session] is used for communications, the user identity and password of the requester are passed to the communications facility of the [remote] server system for validation. This process occurs before any part of a DDM architecture server is invoked . . . .
Similarly, when a DDM architecture command is received by a server, the remote requester's rights to issue the command and to use the resources it requests are validated by the [local] security manager. Here too, no [centralized] interfaces are defined by DDM architecture for performing these validations. The use of local security facilities is assumed. However, DDM architecture does define a variety of messages for reporting any authorization violations back to the client.
In the current levels of the DDM architecture, the security manager is essentially just a stub that represents whatever security facilities are available on the local system. No DDM architecture messages have yet been defined for working with or modifying the authorizations of users to server resources. All such changes to user authorizations must be performed by logging onto the system that owns the resource. Clearly this is an inconvenience to users, and clearly, supporting these services would be a desirable enhancement to DDM architecture.³ ³ Ibid, pp. 475-6. Emphasis added.

As late as July, 2004 IBM's thought leadership in this area of DDM, and specifically DDM's assumption of independent local security administration facilities, is still being honored in the industry. Microsoft's Host Integration Server 2004 (HIS2004) product guide touts its use of IBM DDM:
All these [Data Integration layer of HIS2004] services make use of IBM mainframe-based products that implement the IBM Distributed Data Management Architecture (DDM). DDM defines the “how to communicate” and leaves it up to individual platform vendors to implement the DDM architecture. IBM currently supports DDM for most IBM platforms, including: z/OS, OS/390, AS/400, RS/6000-AIX, and AS/36.⁴ ⁴ Microsoft Mainframe Integration Server 2004 Product Guide, July 2004, p. 10.

As a result, it remains generally true today that computer security revolves around the local security manager. This paradigm holds true for most individual computer systems, major operating system platforms including IBM Multiple Virtual System (MVS), Sun Solaris, Hewlett-Packard HPUX, IBM AIX, Linux operating systems and Windows operating systems (when not using the Active Directory domain features), also operating system groups like IBM AS/400, Macintosh MacOSes, IBM AS/36 and others with less market share. It also holds true for most relational database systems and even some large commercial server applications that do not allow “pass-through” authentication and/or authorization from the operating system. Each platform, if not each computer or even each application, is typically its own island of security administration.

A cultural effect of this isolation has occurred. Computer professionals often become deeply affiliated with only a few of these islands, largely because of the steep learning curve of moving between them. This and other factors contribute to what is currently a cultural divide between computer professionals practicing in these three relatively isolated “islands.” After years of independent innovation and refinement of the security systems and processes on each of these islands, there is significant difference between them in terms of what is secured, and how to secure things; even definitions of “perfect” security—security goals and ideals—are different, shaped by historical embarrassments or successes local to the “island.”

Behind these isolated systems is the fundamental IBM DDM assumption, “The use of local security facilities is assumed.” That the design of DDM security remains unfinished is expressed by the admission that: “No DDM architecture messages have yet been defined for working with or modifying the authorizations of users to server resources.”

One motivation for this invention is to discard the assumption of local security facilities and complete the DDM conception of distributed security. The invention does this by creating a unified, centrally managed store of user, group, resource and authorizations data that can be accessed in a format that is both native to the existing local security managers and fits within the existing cache and performance requirements of these local security managers. However, this motivation is held in tension with goal of compatibility with existing systems that already control local security access. Another goal held in tension with the motivation is to satisfy performance requirements. The current gap between existing local security access performance requirements, ranging from thousands to millions of access requests per second, and the network delays and other latencies inherent to distributed service requests is orders of magnitude apart. For example, an optimized and maturing distributed service like Lightweight Directory Access Protocol (LDAP) can satisfy only hundreds of requests per second.⁵ ⁵ Performance benchmarks from two independent tests of multiple LDAP products. Test results indicate that LDAP can service tens to hundreds of requests per second, taking several tenths of a second for each request: http://www.mindcraft.com/perfreports/ldap/netscape/dirserver10.html and http://www.globus.org/testing/dmark_results.html

The motivation for this invention recognizes that the use of local security facilities' authorizations is harmful. By quitting the IBM DDM assumption (above) and then consolidating security authorizations data into a centralized security facility a great deal of help can be done to simplify computer security administration. Such help is not only about security administration; as IBM's architect Demers said, it “would be a desirable enhancement to DDM architecture,” because “clearly this is an inconvenience to users.” These local authorization groups are both inconvenient and harmful to effective security because:
There is an overwhelming quantity of them
There is typically poor documentation about what they mean
Using them can produce unexpected results, achieving more or less than what was intended
There can be interrelationships and conflicts between them
They tend to be “low level” (i.e., more closely related to their technology implementation than to the people who use them).

The localization of authorizations groups obfuscates them, making it conceptually difficult to centralize and coordinate an effective security program for an organization as a whole. Maintaining local security facilities using virtually “private” databases of obfuscated authorizations groups makes it too difficult to organize security controls at a higher, organization-wide level. Local security facilities by their nature create a conceptual gap—and that is “harmful” to the art.

### NARRATIVE DESCRIPTION OF THE INVENTION

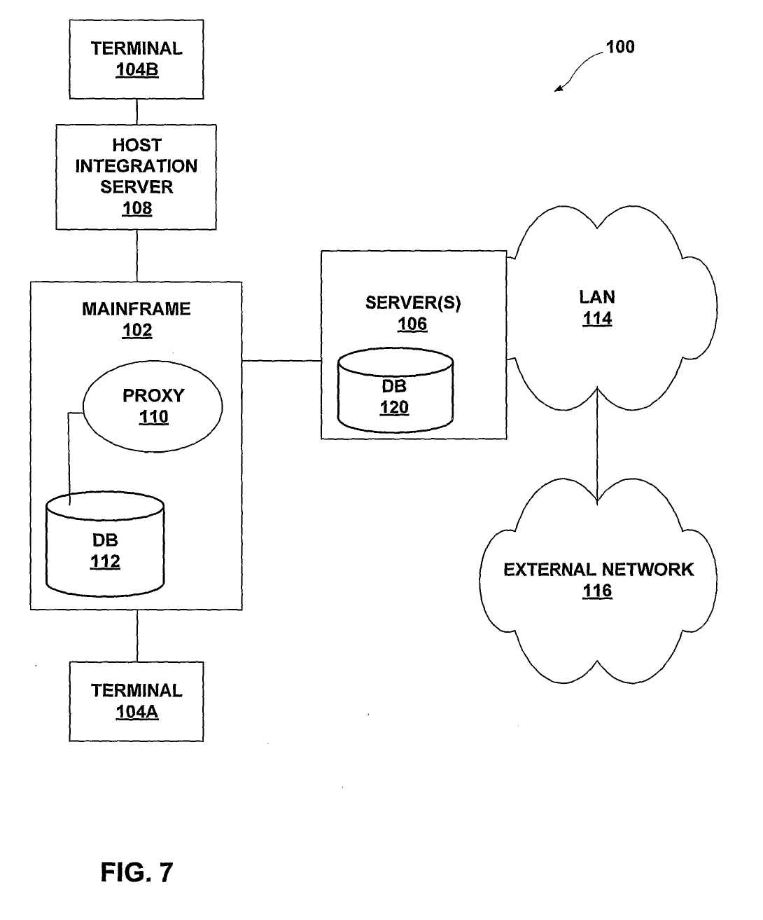

FIG. 7 is an exemplary block diagram illustrating a system that may carry out one or more embodiments of the invention. System 100 includes a mainframe computer 102, and a terminal 104A that logs on and uses mainframe computer 102. System 100 also includes one or more servers 106 that define and control security access to mainframe computer 102. Servers 106 may include the software and database referred to herein as RAC-AD Server or “RAC-AD device,” which may reside on the Windows AD Domain Controller Server hardware. RAC-AD stands for Resource Access Control-Active Directory. Database 120 is specifically illustrated in FIG. 7, and it is understood the software executes in servers 106, as described herein, to generate the data for database 120. Mainframe computer 102 may include proxy 110 and cache database 112, also referred to herein as the RAC-AD Proxy and Cache or “Proxy” software, which resides on the mainframe and integrates with MVS as described by the API's in the IBM RACROUTE Macro Reference. Database 120 may comprise a lookup table having pre-computed access information for every possible user and every possible resource. Cache database 112 may comprise a subset of database 120, e.g., a lookup table having pre-computed access information for every possible resource, but only for one or more users that have recently requested authorization.

Terminal 104A may communicate directly with mainframe computer 102 via a mainframe protocol such as SNA, or alternatively, terminal 104B may communicate with mainframe computer 102 via a host integration server 108. Host integration software is commercially available from Microsoft Corporation and can allow terminal 104 to communicate via TCP/IP protocol or another protocol. In this case, host integration server 108 may convert the communication from TCP/IP protocol to a mainframe protocol recognized by mainframe 102, without the need for additional protocol conversion processing in mainframe 102. Moreover, in some cases, host integration software may also be executed on servers 106 to allow one or more terminals of local area network (LAN) 114 or external network 116 to access mainframe computer 102 through servers 106. In this case (not illustrated), terminals may communicate with mainframe 102 through servers 106. LAN 114 may comprise a business or enterprise network, and external network 116 may comprise another LAN, a wide area network (WAN), or possibly a global network such as the Internet.

In accordance with the invention, various authentication and authorization functions conventionally performed internally by mainframe computer 102 are delegated to one or more external servers 106. This yields at least two very useful advantages. First the processing power of mainframe computer 102 is not burdened with extensive authentication and authorization processing functions, allowing the relatively expensive processing power of mainframe computer 102 to be put to more important use. Second, servers 106 can allow for improved security flexibility and functionality to network administrators, by utilizing the functionality of Microsoft Access Control Lists (ACL's) and Windows-compatible security administration tools to administer mainframe security access.

Mainframe computer 102 includes a proxy 110, which comprises a software program that facilitates communication with servers 106. Other than proxy 110, mainframe computer 102 may operate in a manner very similar to a conventional mainframe computer, unaware that its security is delegated to servers 106. Mainframe 102 may generally perform as though its security is being performed internally in conjunction with a conventional RACF and an attached Direct Access Storage Device (DASD, similar to a hard drive). However, proxy 110 replaces the conventional RACF, and loads database 112 with data from servers 106, whenever particular users attempt to connect to mainframe computer 102, for example, using a computer such as a terminal or terminal emulator or related system capable of requesting authentication and issuing commands to the mainframe. Mainframe computer 102 may copy its local security database to servers 106, thinking it is coping such data to a hard drive, as would be the case for conventional mainframe security management.

Servers 106 operate independently of mainframe computer 102, pre-computing the access for every possible user of mainframe computer, and every possibly resource for such users. Moreover, if a network administrator changes the access of one or more users, servers 106 can re-compute the access for those users of mainframe computer 102. In this manner, access to mainframe resources for every possible user, such as access to a file, a folder, a transaction, a database element, a database table or a terminal session associated with the mainframe computer, can be pre-computed by servers 106, eliminating the need for mainframe computer 102 to perform the computations.

When terminal 104A makes an authentication request to mainframe 102, or when a mainframe user requests authentication from the mainframe by way of another computer such as a terminal emulator or other mainframe-connected device, mainframe 102 can route this security service request to proxy 110 which can in turn route this request for service to be fulfilled by server 106. Server 106 can receive information indicative of the request, perform a lookup against the Windows Active Directory (AD) system, and respond to the request with the Windows AD system's true/false response in a way that mimics the response generated by a conventional mainframe computer security subsystem. The authentication element sent by terminal 104A may be a password, or possibly another element such as a biological indication of the user, i.e., a finger print scan, voice scan, retinal scan, or possibly a proof of assurance that the user has in his or her possession a fob, key, token or similar device, or other authentication proof or combination of proofs such as is commonly practiced.

As an added advantage, the security arrangement of system 100 can allow for synchronization and identification of different user passwords associated with a common user. For example, a user may have an 8-character user ID associated with mainframe access, but may have a different user ID and related authentication information such as a password, etc., for servers in a Microsoft AD Server environment. In this case, when terminal 104A sends its 8-character mainframe user ID to mainframe 102, proxy 110 may be configured to query the user for the Microsoft AD user ID and password, and authenticate these against the Microsoft AD system. From this point forward, the fact that the same user has different user ID's (and passwords, etc.) is known by system 100, and by the administrators of servers 106. This explicit and reasonably certain connection between different user ID's related to the same actual person can be very beneficial for auditing in a business setting. The passwords may also be synchronized such that the Microsoft AD password becomes the mainframe password, or vice versa.

After the user of terminal 104A (as in this example; or other mainframe-connected user session) has been authenticated for mainframe computer 102, terminal 104A can make an authorization request, in attempt to access one or more resources of mainframe computer 102. Terminal 104A may think it is communicating with a conventional Resource Access Control Facility (RACF), but proxy 110 replaces the RACF. Thus, terminal 104A makes its authorization request to proxy 110. The authorization request may include a user ID for mainframe 102 and a resource ID for the resource of mainframe that the user wants to access, and the level of access to the resource requested by the user (for example, read, write, execute, etc.). Proxy 110 performs a lookup in cache database 112 to identify an ID for terminal 104A that server 106 recognizes. This “universal user identifier” may be the Microsoft AD Globally Unique Identifier (GUID) number that uniquely identifies this user in AD and is theoretically unique from any other user identifier generated by Microsoft AD systems.

Proxy 110 sends information indicative of the authentication request to servers 106, i.e., sends the user ID and the resource ID and the access level requested by the user to servers 106. Servers 106 can perform a quick look up for the user ID to obtain a list of authorized resources for this user, and that list can be compared to and filtered by the resource ID to determine the maximum access level that may be allowed or granted to the user for this resource. Given the additional context of the request (for example, time of day, terminal in use, etc.), a yes or no answer (indicating that the user should be granted or denied the request) can then be provided in reply to proxy 110, which can be forwarded to mainframe 102, which then functions as is customary in cases of granting or denying the requested access to the user.

However, more preferably, upon receiving an authorization request, severs 106 can send to proxy 106 of mainframe computer 102 a subset of its pre-computed information pertinent to the current user of terminal 104A. Proxy can store this pre-computed subset of information in a data cache defined in database 112, using a per-user cache structure and possibly a general cache structure. From this point forward, any authorization request by the user of terminal 104A can be looked up by proxy 110 locally in cache database 112, preferably without incurring mainframe input/output device delays. A time limit or session limit, however, may be defined so after the time limit expires, proxy 110 must update its local database 112 with new data in server 106. Moreover, a mechanism such as a “valid bit” may be defined for the date in database 112, and this “valid bit” may be set to “invalid” by server 106 when an administrator makes any authorization changes. The notion that a Microsoft server can invalidate the local security data of mainframe computer 102 may be radical, but it allows for improved administrator controls to make security enforcement and policy decisions more uniform across the enterprise resources protected by the Windows AD system and the mainframe system.

Once cache database 112 is loaded with a subset of pre-computed access information for the user of terminal 104A (as in this example; or other mainframe-connected user session), proxy 110 can perform simple lookups with respect to any future authorization request from terminal 104A. Proxy 110 sends yes or no answers to the mainframe operating system which in turn executes or denies the requested access and commands of the user of terminal 104A. Proxy 110 may need to refresh database 112 periodically with any new data generated by servers 106. Moreover, as mentioned, a mechanism such as a “valid bit” may be used to ensure that any old data in database 112 is not used for authentication if such data has changed.

By removing conventional RACF processing from mainframe computer 102, the processing power of mainframe computer 102 can be used for more important processing applications. Moreover, by pre-computing authorization in servers 106, such processing can be performed in the background in a relatively constant fashion. Thus, the fact that servers 106 do not have the processing power of mainframe computer 102 is of little consequence because the benefit of increased processing time can be exploited by servers 106 since they perform pre-computations prior to the need for the authentication information.

Moreover, the techniques described herein allow for improved security flexibility and functionality to network administrators, by allowing the administrators to use Microsoft Access Control Lists (ACL's) in defining security for mainframe 102. In other words, resource security of mainframe 102 can be removed from the conventional IBM paradigm outlined herein. Microsoft ACL's are more user friendly for security administrators and have a large body of compatible software that can be used to automate security tasks, so extending such functionality to mainframe security can provide paramount improvements in security management, particularly for large businesses that use mainframe computing for any purpose.

The invention also allows for so called “opt-in” of mainframe security, such that only those users that access mainframe 102 going forward, need to be defined and identified by servers 106. For example, when a user logs on to mainframe computer 102 with a legacy 8-character user ID, mainframe 102 can prompt the user to provide its Microsoft AD user ID. Henceforward, system 100 can make the connection between a given user and the different IDs that may exist for that user. Such identification of the connection between a given user and the different IDs can be particularly advantageous for auditing in large companies. Consolidation of user passwords, and the use of existing Microsoft AD compatible strong non-password authentication mechanisms could also improve the user experience and the overall systems security as part of the opt-in process of logging in to the mainframe.

### Comparisons

### Inside the Mainframe

IBM designed its RACF product to be modularly replaceable and IBM documented guidance, programmer-level APIs and data layouts to promote the development of such products.⁶ It is commonly understood that IBM mainframes may use one of three commercially available access control facilities: RACF, ACF2 or Top Secret.⁷ None of these products implements or is compatible with the consolidation of local security facilities' authorizations databases into an organization-wide security facility that allows non-IBM operating systems to participate without maintaining their own local security facility. (NOTE: Later developments towards security consolidation are considered below, see “Security Consolidation Products”) ⁶OS/390 Security Server External Security Interface (RACROUTE) Macro Reference, IBM. See Appendix D. See also: OS/390 Security Server (RACF) Data Areas and other publications from IBM.⁷ Hinsch, Bethany, “ACF2 Mainframe Security,” SANS GIAC Practical Repository paper, 2003, p. 1.

### IBM RACF™ Security Server

The exemplary local (to the mainframe) resource access control facility. Introduced in 1976 by IBM. IBM estimated in October 2000 that RACF had climbed from a 28% market share in 1986 to what could be expressed as a 64% market share⁸. ⁸ IBM CA-ACF2 to OS/390 Security Server Migration Guide, p. 8.

### Computer Associates ACF2

A competitor to RACF, described in comparison to RACF in IBM's ACF2 to RACF Migration Guide. Created by a company named SKK in 1978, and sold to Computer Associates, Inc. in 1987.

### Computer Associates Top Secret

Another competitor to RACF, described in comparison to RACF in IBM's Top Secret to RACF Migration Guide. Now includes the LDAP Server with the product name of eTrust DSI.

Top Secret LDAP Server (eTrust DSI)

The 2003 Product Road Map includes a description of the extension of their core RACF replacement to include LINUX PAM, DCE remote access, and LDAP-TCP/IP remote access to their core security database. Please see the general discussion of OSF's DCE and PAM above.

This 2003 Product Road Map also includes a discussion of “Enterprise Identity Mapping.” CA's EIM enhances the user experience of an LDAP central replica of security information, but does not help consolidate security databases: “The implementation of EIM entails creating and maintaining ‘mapping’ definitions that are used to find a user's identity for one system when given the identity from another system.”

LDAP Directory Services (LDS) in release 5.3 allows the synchronization of the Top Secret LDAP directory with any other LDAP directory, including Microsoft AD. While an LDAP synchronization could, subject to performance comparison with this invention's function as a real-time translator, achieve a very similar functional result, the underlying technology is fundamentally different. Rather than offloading much of the RACF access control processing, RACF security data storage and TCP/IP processing burden to a “smart” mainframe device, the Top Secret approach keeps all existing security processing and adds additional burden due to the additional storage and processing of all replica (subordinate) security data.

### Mainframe Devices

### Thales Security Resource Manager RG1100 for IBM MVS

Provides simple API to mainframe programmers from a channel-attached, bisync, or SNA device. In operation, this device offloads cryptographic processing functions from the mainframe.

### Bus-Tech Device Suite

Includes variations on channel attached devices that appear to the channel/mainframe as either an SNA Gateway or an Open Systems DASD storage device.

### Bus-Tech NetShuttle™ for Microsoft Mainframe Integration Server

Bus-Tech now rivals what Polaris Communications was in terms of innovative integration with Microsoft's Mainframe Integration Server. The following are excerpts from a whitepaper touting a product of this description:
“A high-performance communications controller for connecting SNA and TCP/IP networks to IBM-compatible mainframes. Built on a ruggedized rack-mount system, NetShuttle attaches directly to your mainframe using one or optionally two ESCON connections. NetShuttle connections use IBM enabling technology to guarantee channel compatibility . . . .
“Built on Microsoft's Windows 2000 server, NetShuttle includes Microsoft's latest [sic] Mainframe Integration Server 2000 software to provide a high-speed SNA Gateway . . . .”

More information on such products may be found in the whitepaper at: RAC-AD Research\Post12-03-2004\Bus-Tech_NetShuttle-with-HIS-11-02.pdf

### TCP/IP to SNA Mainframe Network Connectivity

SNA is the original invention (by IBM) for how to securely access the resources on a mainframe. Its design dates back to the mid 1970s and was designed in conjunction with IBM DDM as discussed in the Background section of this paper.

The invention described herein does not use SNA to access the mainframe; instead, it impersonates a device like a DASD hard disk storage system. This is a fundamental difference, and may be compared to the difference between a client or terminal accessing the mainframe and a device being accessed by the mainframe. SNA was developed to support network conversations with terminals that had no disk drives—the challenge this protocol overcame was to allow hundreds of thousands of people to type instructions and perform light data entry simultaneously. There are drastic throughput differences between the data a person typing at a terminal can send to the mainframe, and a state of the art disk drive connected via 200 gigabits per second (Gbps) FICON Express. This extreme difference in the design and performance expectations between SNA versus current channel-attached devices underlie the difference between SNA to TCP/IP translation software and the invention described in this paper.

### Microsoft SNA Server/Mainframe Integration Server (Renamed)

Performs both network and application-level translation of mainframe resources to Windows-based access requesters/users. This Microsoft product uses the IBM SNA network protocol to access the mainframe through a front end processor or similar device, and it leaves RACF (or similar local security products) in control of authorizations. Much of Microsoft's SNA/HIS Server platform is helpful to this invention: while the underlying SNA architecture is different, the user interface and level of convenience that HIS achieves to the Windows user sets the standard of excellence for this invention.

HIS users may access the mainframe databases using Microsoft “standards” including ODBC, OLE-DB, COM and .NET, each of which follows the IBM DDM assumption of using local security facilities to control actual access to resources. HIS also enables synchronous and asynchronous messaging, and bidirectional initiation of transaction processing requests. At the core of the HIS product is the SNA Server which acts as a router or gateway from Microsoft networks to the mainframe SNA resources.

### Sun Link/Alebra Brixton and Express

Provides a UNIX-client with a gateway to the mainframe by bidirectionally translating clients' TCP/IP traffic into SNA and LU6.2.

### Bus-Tech ESCON/FICON—PCI Card and Software

These solutions are both mainframe devices and TCP/IP to SNA networking router systems. The card hardware allows PC's using Intel/PCI architecture hardware (typical of Windows hardware) to connect to mainframes as devices. Includes software to allow routing and packet conversion from TCP/IP to SNA.

### Crossroads ESCON/FICON—PCI Card and Software

Technology is the same as above.

In Feb. 3, 2000 Crossroads acquired Polaris Communications for the purpose of mainframe-enabling its existing Open Systems-based Storage Area Networking systems, so that their SANs appear as DASD devices via ESCON/FICON. Before the acquisition, Polaris Communications authored a Microsoft Whitepaper on integration of Windows with the mainframe coinciding with a release of Microsoft's SNA server. Polaris Communications was a thought leader in this area.

Vanguard ez/AccessControl

“ez/AccessControl provides a single point of access control, routing all request for access to a drive, file, or directory on a Microsoft Windows NT, 2000, or XP platform through the IBM Security Server™ (RACF®). Ez/Access Control intercepts all access request on a particular Windows machine and communicates that request via TCP/IP to the mainframe, where it presents the request to RACF. RACF performs standard profile checking and the result is transmitted back to ez/Access Control on the Windows machine. At that point, ez/Access Control finishes the transaction by either denying or granting access. Windows resource security no longer plays a part.” This arrangement does not provide simultaneous bidirectional translation of the access control rules, nor of the users or resources from Windows. It may suffer from performance problems from the Windows user perspective due to network latency in cases where a large number of access control checks must be processed in a short time, for example, a “grep” or text search against a large number of files, or similar cases where many files must be opened for processing. Finally, in a large Windows domain (for example 100,000 machines) each with 100 GB hard drives there are many more “resources” to protect than RACF typically handles (10,000,000 GB of filespace is large even for a mainframe!). Since the Windows (and UNIX) styles of filesystem use may be characterized by a prolific use of many files on cheap disk space, it is true in a loose sense that most local Windows hard drives do not merit RACF-based resource protection.

### Security Consolidation Products

### Massachusetts Institute of Technology's Kerberos

Kerberos is a cryptographic-based method and networking protocol for one server among many to vouch for the authenticity of an access requestor (user) using a cryptographically signed “ticket”. MIT's efforts to create Kerberos are still considered cryptographically strong and are considered by many professionals to be difficult to fully understand. Tickets simply state that the use was authenticated at a certain date by a trusted server; authorization was not a design goal for the MIT versions of Kerberos.

Microsoft adopted the Kerberos protocol as the foundation for its Active Directory implementation in its Windows 2000 product line, and this foundation also undergirds Windows 2003 Server and remains prevalent in known plans for its next server operating systems. Microsoft extended the use of this protocol to include within the cryptographically-protected ticket payload a list of all of the user's authorizations. Such a list is ignored by most implementations of Kerberos because it is an optional field, and also Microsoft's proprietary format of the authorizations list may not be understood by these implementations. Since Windows 2000, the Active Directory extension of Kerberos can be used as an authorization mechanism unlike many other implementations of this protocol.

Kerberos and DCE both rely on a Universally Unique Identifier, or UUID. Microsoft calls this a Globally Unique Identifier or GUID. UUID's are used to uniquely identify users regardless of their “home” or originating local security facility. UUID's are also used to uniquely identify security authorization groups, and also to identify “domains” a.k.a. “DCE cells” which are specific groupings of computers. Microsoft Active Directory domains utilize this terminology. It is the use of the cryptographic hashing algorithms to create statistically strong guesses at what should be universally unique identifiers that bootstraps Kerberos and DCE “up” from the concept of a central server and allows Kerberized participants to accept the authentication judgments of what it considers a peer server. This is due to the Kerberos Authentication mechanism, which is diagrammed in overview at many sites on the World Wide Web. In other words, Kerberized servers don't have to invoke a higher authority from a central, monolithic single source in order to authenticate from one server to the next one. After the initial authentication to any first server, the next servers simply check for a valid ticket.

Kerberos servers who accept a valid ticket from an access requestor can make their own local security management decisions about granting access to specific resources without violating any part of the Kerberos protocol. This separation of authentication from authorization is optional and is made possible because of some of the nuances of public key cryptography. In the enhancements that are part of version 5, Kerberos now passes authorization information generated by others, but does not generate or directly process authorizations:
Kerberos does not itself provide authorization, but V5 Kerberos passes authorization information generated by other services. In this manner, Kerberos can be used as a base for building separate distributed authorization services

AD domain controller servers in Windows 2000/2003 use an optional field (IF-RELEVANT, ID 1) in the Kerberos v. 5 specification to place a proprietary data structure they call the “PAC” (possibly for Private Authorization Credentials). As a result, AD-Kerberos implementations receive the authorizations group list (efficiently named by their GUID's), and as such, via Kerberos 5, have received additional Kerberized help on how to make the decision about whether to grant or deny access to a specific, local-to-this-server resource (one that Kerberos doesn't know about, since it doesn't keep track of any resources). Microsoft required a license to view its authorization specification version 1.0 for Windows 2000 of April 2000. Thus, AD-Kerberos technology uniquely allows for the consolidation of local security facility databases into what is most correctly called AD. Again, the proprietary Microsoft Kerberos 5 implementation that includes the PAC uniquely enables this invention compared to other implementations of Kerberos 5. Finally, it is important to note that IBM has implemented both DCE and Kerberos V on MVS as of October 2000, but these implementations are not as useful to this invention because they are not extended to behave like Microsoft Active Directory, using its PAC authorizations list. IBM could license this technology (the AD-specific Kerberos extensions that put the authorization list into AD-Kerberos tickets) from Microsoft to make this possible, but that seems unlikely at this time.

A Kerberos overview reference by Microsoft can be found at: http://www.microsoft.com/technet/prodtechnol/windows2000serv/deploy/confeat/kerberos.mspx

The following excerpt is taken from the Microsoft resource referenced above:
How Services Use Authorization Data
In Windows 2000, services act in their own security contexts only when accessing resources on their own behalf. For the most part, this is just when they are doing their own housekeeping-accessing configuration data stored in registry keys, binding to communications ports, and completing other tasks not related to work for a particular client. When a service does do something for a client, it impersonates the client, acting in the client's security context. This means that in addition to identifying clients, Windows 2000 services must also take on some of their characteristics-specifically the client's level of authorization on the system.
When a service sets up housekeeping on a computer running Windows 2000, it calls the SSPI method AcquireCredentialsHandle to gain access to its own credentials—the secret key for the account under which the service runs. The service then binds to a communications port, where it listens for messages from prospective clients.
When a client requests a connection and presents a session ticket, the service asks the Kerberos SSP to verify the client's credentials by calling the SSPI method AcceptSecurityContext, passing the client's session ticket along with a handle to the service's secret key. The Kerberos SSP verifies the ticket's authenticity, opens it, and passes the contents of the authorization data field to its parent process, the LSA. If the data includes a list of SID's, the LSA uses them to build an access token representing the user on the local system. In addition, the LSA queries its own database to determine if the user or one of the user's security groups is a member of a security group created on the local system. If any are found, the LSA adds those SID's to the access token. The LSA then confirms to the calling service that the client's identity has been authenticated, enclosing a reference to the client's access token.
On receiving confirmation, the service completes its connection with the client and attaches the client's access token to an impersonation thread by calling ImpersonateSecurityContext. When the impersonation thread needs access to an object, it presents the client's token. The operating system performs an access check by comparing SID's in the token to SID's in the object's ACL. If it finds a match, it checks to see that the entry in the ACL grants the level of access requested by the thread. If it does, the thread is allowed access. Otherwise, access is denied.

### OSF DCE

The Open Software Foundation created the Distributed Computing Environment (DCE) under somewhat philanthropic motivations so that people would not have to buy in to expensive, licensed software or hardware in order to use remote software. Open Source DCE clients should be able to request specific computer processing services from DCE servers, they proposed, using their Open Source (free) methods.

OSF DCE's Distributed File System (DFS) offers a promising, Kerberos-integrated file sharing security mechanism, designed to protect passwords used to log into remote systems. However, this system as described in the RFC (http://www.opengroup.org/tech/rfc/rfc96.0.html) does not intend to replace the local security facility, as noted in this excerpt:
File access mapping between NetWare and DFS
Using only the rights acquired by logging into NetWare, a user can access DFS files without having to login to DCE. DFA maintains a table which maps user names registered to NetWare to those registered to DCE, and uses this (and the DFS ACL's) to check users' access rights to DFS files. NetWare users can acquire the access rights that belong to the DCE group to which their corresponding DCE user name belongs. If, however, a user has the access rights both of a DCE user and of a DCE group, the latter is ignored.
DFA makes no conversion between NetWare and DFS groups. Thus, a NetWare group access right cannot be applied to DFS files and directories. See Section 2.6.1 for information on administering user names and group names.

This quotation shows that DCE adds a “higher authority” in addition to existing local security authorities (NetWare in this early example). The key difference between the OSF DCE DFS art and this invention is that DFS provides no translation between the local security facility's groups and its own. This invention allows a Windows AD group to protect a resource on the MVS platform, and a group defined from within MVS using a RACF look-alike (RAC-AD) to protect what appear to be AD resources, effectively translating and ultimately consolidating the total number of groups in use at a company, enterprise or other organization.

As of this January 1996 RFC (http://www.opengroup.org/tech/rfc/rfc92.0.html) OSF DCE version 1.2 officially interoperated with MIT Kerberos version 5.

Earlier versions of either product were not guaranteed to interoperate by either organization.

Microsoft hired one of the original architects of the Apollo (then Hewlett-Packard when acquired) Network Computing Architecture, which was submitted to the Open Group and become DCE/RPC. This Microsoft/Apollo architect helped Microsoft create MSRPC, which closely resembles DCE/RPC, but which allowed Microsoft to own its own non-DCE version and thus avoid paying a $20/seat license fee to DCE. This is according to this Internet lore: http://www.samba-tng.org/docs/tng-arch/tng-arch05.html#113

### Vintela Authentication Services (VAS)

www.vintela.com

Vintela's VAS uses some of the principles mentioned in this paper to build a UNIX to AD authentication pass through. Innovative small company started just over 1 year ago, already achieving tremendous sales success among the Fortune 100 Companies in the US. Lead product is its commercial Pluggable Authentication Module (PAM) that authenticates UNIX users to Microsoft AD; other products introduced in 2004 include AD integration for Java and for UNIX system management leveraging the Windows AD Group Policy Objects (GPO) and Windows Management Initiative (WMI) technologies. Vintela products, generally, make the UNIX/LINUX systems appear within the AD paradigm, such that UNIX systems can be acted upon by “native” Windows management and end-user products.

### LDAP Products

The Lightweight Directory Access Protocol (LDAP) standard supports high-volume, read-optimized databases containing security information (including but not limited to: user identity information, passwords, certificates and authorizations for users and groups to defined resources). Its standardized data format is platform-neutral, and has been implemented by IBM, Computer Associates, Sun, Netscape, Novell, Microsoft and others as part of their core security offerings. However, LDAP is not widely used compared with local security facilities which are ubiquitous. LDAP directories, except in the case of Microsoft Active Directory, are secondary to the local system security facility. As a direct result, LDAP directories usually copy or replicate or synchronize security data from participating local security facilities, maintaining it as a secondary read-only store, or employ bidirectional synchronization with their data sources. The local security facilities continue to be authoritative over the LDAP store, and only the local security facilities actually enforce (grant or deny) access requests to resources. As such, LDAP does not typically consolidate security databases but instead creates a centralized replica—or duplicate—of the authoritative security data.

### DETAILED DESCRIPTION OF INVENTION

### Overview

The high-level diagram of FIG. 2 shows three main existing technology components:
A mainframe computer, an IBM Multiple Virtual System (MVS) or Virtual Machine/Enterprise Systems Architecture (VM/ESA) or compatible system using either IBM's Resource Access Control Facility (RACF) or a “non-RACF external security-manager product” that complies with IBM's guidance for building such a security manager, as described in the RACROUTE Macro Reference cited above.⁹ ⁹ For the purposes of this disclosure, the technical discussion below will prefer a more generalized usage of “RACF” to mean either IBM's RACF® product or any “non-RACF external security-manager product” that complies with IBM's guidance for building such a security manager, as described in the RACROUTE Macro Reference cited above. When the IBM RACF® product is intended it will be specified as in this sentence.
A mainframe hardware device communication channel using either IBM Bus and Tag, Enterprise System CONnectivity (ESCON), Fiber Connection (FICON) or related mainframe device architectures
A Windows AD Domain Controller Server or “Windows Server” computer using at least one mainframe channel-attached connection and one network connection to the Microsoft Windows Active Directory domain.

FIG. 2 indicates one method for implementing the invention, using a channel-attached storage device that simulates mainframe peripheral hardware as a Direct Access Storage Device (DASD). This DASD will also run the Microsoft Windows 2000/2003 (or future release) operating system as an Active Directory (AD) Domain Controller, and the invention software. Software that is also a part of this invention will run on the mainframe and will relay security commands to the DASD device and relay and cache its responses to appropriate mainframe subsystems etc.

The invention consists primarily of software that resides and executes on these existing technologies, given the hardware configuration as shown. The software is indicated in the diagrams by the use of glowing blue rectangles and will be referred to by these names. The numbers directly below correspond to the numbers of FIG. 2
1. The RAC-AD Server or “RAC-AD device” software and database resides on the Windows AD Domain Controller Server hardware
2. The RAC-AD Proxy and Cache or “Proxy” software resides on the mainframe and integrates with MVS as described by the API's in the IBM RACROUTE Macro Reference

Narrated examples will further describe the uses and advantages of the invention. These narratives will show the motivations for this invention, and will describe how its fulfillment of the following common security functions (both in the mainframe paradigm and in the Windows AD paradigm) is advantageous over a local security model. The narratives are:
3. User “Opt-In”
4. User Sign On
5. Resource Authorization/Access Check
6. Common Security Administration

Last, the implementation of the invention will be further described for these aspects of the invention:
7. RAC-AD Device Data Model: Authorization translation engine
8. Cache Data Structure: User view of Resources and Access
9. Windows IFS file system extension characteristics
   Components that May be Used to Implement the Invention

### 1. The RAC-AD Device (Server Software and Database)

The RAC-AD Device, shown as item 1 in FIG. 2, appears as DASD to the mainframe but runs Windows compatible server software for it operating system and suitable computer hardware that is typical of a Windows server. Extensions and innovations to such an existing Windows system are described below.

### Resource Access Control File System (RACFS)

The RAC-AD device presents the same security data to the Windows paradigm and the RACF paradigm. To the Windows paradigm this file system has the following appearance:
It appears as a formatted, installed filesystem to the Windows operating system, and integrates with existing Windows operating system functions
It can be shared using AD or other Window file sharing
It can be browsed using Windows Explorer (Explorer.exe) both on the local server and remotely using any of the Windows file sharing mechanisms
It can be used as a file system by applications such as web servers, database servers, etc.
Files can be “opened” in the Windows paradigm way by associating an application with a file type on double click, etc.
Files and directories can be copied, moved, etc. using standard copy/paste, drag/drop and command line interfaces common in the Windows paradigm
AD groups and users may be assigned privileges to files and directories (see explanation below)
Its security management is similar to the New Technology File system (NTFS) or File Allocation Table (FAT/FAT32) format file systems common in Windows, but it stores locally the security metadata that directly manages the security of remote mainframe DASD and resources

For the convenience of this paper, this filesystem implemented in a Windows server using typical Windows program interfaces will be referred to as RACFS, based on eliding the RACF name with the NTFS name.

### RACF Resource to Windows Filesystem Translation

Strictly speaking, RACF files are not stored within folders or directories as users of Windows and UNIX systems are accustomed to. However, some strong similarities exist between the strict file naming convention on RACF, using qualifiers, and directory naming in Windows 2000/2003 or UNIX.

For example, the following files (datasets/resources) in MVS RACF could be represented in the Windows paradigm as shown in the table below:

| | Mainframe | Windows Command | Windows Explorer |
|---|---|---|---|
| Line | Dataset | Line view | Tree view |
| 1 | AB.CD | C:\AB\CD (folder) | [symbol] |
| 2 | AB.CD.E | C:\AB\CD\E (folder) | |
| 3 | AB.CD.EF | C:\AB\CD\EF (file) | |
| 4 | AB.CD.EFG | C:\AB\CD\EFG (file) | |
| 5 | AB.CD.E.HIJ | C:\AB\CD\E\HIJ (file) | |

Simply substituting the mainframe “.” for the Windows “\” and then locating the “AB” high-level qualifier on a disk drive (the C:\ prefix shown in the center column) creates the translation shown; those skilled in the art could provide additional rules and nuance to complete a robust translation system. For example, improved default sorting rules could make the listing more clearly indicate that “E” was a folder by listing “AB.CD.E.HIJ” (line 5 in the table) directly after “AB.CD.E” (line 2 in the table).

### User View of Resources

The Windows filesystem is typically viewed by users who are authorized to see most resources, an approach that is grandfathered in to this graphical presentation of the file system from the Windows Explorer application (Explorer.exe). Explorer.exe dates from the time of early File Allocation Table (FAT) filesystems which did not support security Access Control Lists (ACL's). This history is opposite from a multi-user system where the filesystem was expected to be very large and users were expected to know and use only a small portion or portions of it. For mainframes IBM's RACF took a “default deny” security approach. This RACF approach makes it more common that the vast majority of mainframe users cannot see or use most of the mainframe resources—both data sets and other resources defined in RACF and external security systems. Thus it is a paradigm shift to present a graphical “view” of the mainframe resources to a mainframe user.

Windows users commonly access files, especially when performing file sharing operations, and associated tasks like accessing networked drives, mapping drives, or accessing more recent Microsoft filesystem enhancements including Active Directory resources and the Distributed Filesystem (DFS). Most mainframe users are typically unaware of the filesystem, that is, the DASD resources like datasets. However mainframe users may be more commonly aware, albeit vaguely, of other mainframe resources. For example, mainframe users may be aware of IBM Customer Information Control System (CICS) transactions that they are authorized to execute, or IBM DB2 database entities to which they have access, even if they do not know the specific names of these resources.

In the RAC-AD translation of the mainframe paradigm, the User View of resources will be similar to the existing Windows Explorer graphical user interface view, but with significant reductions to the actual list of resources that will be displayed to the typical user. The user will see only the resources to which he or she currently has access to, as listed in the RAC-AD device's answer cache for this user. This answer cache will be a subset that has, in the typical user case, a much smaller cardinality than the full list of all mainframe resources. Also, due to RACF's capability to create Profiles for resources with the wildcard “in the middle” of the resource naming specification, it is likely that a user may have access to a resource in cases where that user does not have access to what in the Windows paradigm is considered the parent folder or folders. This will require that the user view find an acceptable graphical device to show resources that are “within” a folder of which the user cannot request a full list of contents. The standard dotted-style mainframe resource name (for example, AB.BC.DE.FG) using “qualifiers” will contain what in Windows would be the full pathname of the file. Because of this it would make sense that in cases where the Windows equivalent of a folder was not listable (due to RACF/RAC-AD privilege settings) that folder would be shown in the Windows folder tree view with only the one (or few) resources that the user had privileges to see.

An intuitive shortcut would be to expand recursively until a folder was found that the user did have list access to; in the case where the user never had list rights to a folder, then the recursive expansion should show all files that the user had access to within one directory, and recursively expand the tree structure showing all containing folders up to the deepest level of folder(s) that contained files to which the user had access. Additional shortcut features similar to the ones described here may be evident to one skilled in the art, for example “expand all” and “expand all for selected folder,” etc. A search field may be helpful for those accustomed to typing text-based data set names. Also, for users uncomfortable with the Windows paradigm an alternate view should be provided that looks and feels more like the existing command line interface and shows the data sets as textual names, not using the graphics and concept of folders containing files.

“Original” Data Sets are Always Remote to this Security Authority

A slight of hand that is required at this point that is common to many graphical displays of “remote” data. The RACFS will only optionally store MVS files on Windows-local disk space. RACFS will store all security data about all MVS/RACF data sets, etc. (files/resources), but will only cache duplicates of MVS resources upon request from Windows-paradigm users. In this respect RACFS will operate similarly to the display of network shares in Windows Explorer, or the TCP/IP application called FTP, file transfer protocol. For example, the Microsoft Windows Explorer application can be used as an FTP client application. When viewing remote ftp files in Windows Explorer, the graphical user interface tree shows files that look just like local disk files, but currently reside remotely and exist only as names on the client computer. However, unlike FTP, in this case the Windows RACFS is the authoritative source for these “remote” filenames and security information due to its physical connection to the mainframe as a device, and integration such that the mainframe offloads and delegates all resource security processing to this authoritative device. To reiterate, the actual data is always remote (on other, remote mainframe DASD) but the data set name and all security properties are authoritatively local to the RAC-AD device. It is this authoritative name and security properties that is actually stored in the RACFS and its presentation by Windows Explorer is not a display of a sent-over-the-wire copy from the server as it would be for an ftp folder or AD share. It also preempts requiring the mainframe to spend CPU cycles querying RACF for data set lists and sending those lists to users browsing for data sets, by offloading this task to the RAC-AD device.

When a user requests that a dataset be “opened” from the Windows paradigm, that user request must first be tested for access to the resource (in many cases some conditions must be tested before rows in the answer cache can be used to grant access given all of the context of the request, for example, time of day conditions). If access is granted for the request then the RAC-AD device will issue an SNA request to the mainframe (either under a service account user or impersonating the user who requested the resource) to perform a dataset copy (or move if appropriate) to the RAC-AD device's DASD. The security administrator or dataset owner should preconfigure the specifications of that file transfer as extended properties for that file (see below, “Double-click/Open”).

### Double-Click/Open

Windows filesystems support the association of one or more applications to a resource, which are used to “Open” the resource, or otherwise perform some default processing operation with that resource. The RAC-AD device may perform one or more of several tasks in order to “open” an MVS file:
Request that the mainframe copy or move the file from its current location in DASD storage to the RAC-AD device, if the resource is a data set
Optionally perform low level data transformations up to and including EBCDIC to ASCII character set translation (this kind of transformation is performed by ftp)
Initiate mainframe processing for a non-DASD resource, for example, a CICS transaction
Open a database table browser compatible with the file format
Create a database link capable of providing ongoing Windows-paradigm database access
Open an error log viewer application to view a log file
Whether the Windows-side copy should be maintained or if the copy is only temporary and should be deleted,
Whether the copy should be kept synchronized or if bidirectional updates should be applied
How many generations of a generational data set to copy
If re-authentication is required to access this resource
Whether encryption must be present between the requestor and the RACFS server
Etc.

This list of examples is somewhat different than what would be done with Windows file systems, since in a Windows-to-Windows file sharing occasion the remote file is almost always operated on by a locally launched and running client application (which may or may not cache the file locally). In this MVS-to-Windows file sharing occasion, it is not safe to assume that a Windows-local execution is desired or even possible.

Note: these tasks all occur after the access check/authorization has completed and granted approval for access, which is discussed in detail in the section titled “Server Data Model: IBM RACF Authorization translation engine.”

### 2. The RAC-AD Proxy and Cache Software

The RAC-AD proxy and cache (Proxy) software resides as a loadable library¹⁰ on the mainframe, and would become memory¹¹ resident at nearly all times in the lifecycle of mainframe operations. It would appear to be RACF to MVS, meaning that it would provide callable API's and send and receive data structures via main memory and mainframe registers like RACF and other non-RACF security facilities (security managers) do. ¹⁰ Or other software format accessible to the mainframe operating system including SAF and RACROUTE macro execution.¹¹ Mainframe main memory or equivalent high performance instruction and data storage location

The Proxy should be aware of the performance characteristics of the RAC-AD device. Such requests will follow the common Input/Output (I/O) protocols for DASD or equivalent storage, such FICON, ESCON or other channel-attached protocol. At a high level, the proxy and cache should function like a sophisticated “device driver” for DASD in the mainframe paradigm: it should be presented with SAF RACROUTE macro requests for data retrieval or storage, and should provide these services at typical mainframe I/O speeds. The data retrieved and stored will always be security manager requests consisting of these three types:
I. RETRIEVE: Sign on and authentication requests. These return either TRUE/FALSE and if true, then retrieving data to fill the ACEE and similar caches; error messages and status and logging must be performed as well.
II. RETRIEVE: Authorization/Access Checks. These requests require extremely fast retrieval of TRUE/FALSE responses to access requests, and are expected by SAF to utilize mainframe main storage (memory) cache instead of I/O. There are a very large number of these requests compared to the other groups when considered over a relatively long period of a month or year.
III. RETRIEVE & STORE: Security Administration functions. These requests store and retrieve the configuration data of the security system, and are generally not critical to mainframe operational performance. In general, Security Administration functions are performed manually by a system administrator in preparation, or as setup tasks, for operational computations like transaction processing, etc.

### SAF RACROUTE Proxy Functionality

When called by IBM MVS Security Access Facility (SAF), this software will encode such program calls for all non-cached actions and return values as a synchronous request to the RAC-AD device. In the mainframe paradigm, such requests will wait for “I/O” until the RAC-AD device responds. All macros described in the RACROUTE macro documentation must be implemented by the Proxy. The following outline groups these required macros and describes the high-level design:

### I. Sign-On and Authentication

VERIFY
VERFYX
SIGN ON

These functions must compare a user name with a password (or other authenticatable “proof” of identity) to provide some verification that a user is who is claimed. These user and password calls will be sent to the RAC-AD device for verification against Microsoft AD domain credentials. The return from the RAC-AD device will include a prefilled cache-able set of authorization/access check data as described below. Optionally, the IBM MVS SAF token-based, and the IBM Passticket authentication proofs will be authenticated by programming code written as part of the Proxy, following the current IBM designs.

### II. Authorization/Access Check

AUTH
FASTAUTH
LIST

These functions work together at a high level to check if a user has the requested access to a requested resource. More specifically, they work to create and manage cached “profiles” which are security administrator-defined control points relating resources to users and/or groups, where each “connection” between these two terms has an associated access level value. Profiles are access rule collections that govern one or more resources. The size of such a collection is limited—only a finite number of users and a finite number of groups (each group having a maximum enrollment of less around 5900) may be defined, and for a given profile the access level can be only one value, not a range of values. Because the systemwide number of resources is likely to be more than the number of users plus the number of groups, IBM RACF® system design is to index their lookup tables by resource name and to use this index first in its algorithms to determine if the requested access should be allowed or denied.

### III. Security Administration

*DEFINE
*EXTRACT
DIRAUTH
AUDIT
**TOKENBLD
**TOKENMAP
**TOKENXTR
NOTES:
*DEFINE and EXTRACT: Allow SAF macros to define and extract lists of defined resources on the mainframe. These macros should generally not be used as RACF functions are preferable.
**TOKEN functions: These functions are primarily performed by SAF and not by a RACF, but can be customized or called by RACF. These are helper functions to using tokens as an alternate authentication method to passwords.

Security administration functions are defined by the RACF product's command line interface and programming API's. For RACF end-user compatibility purposes the RAC-AD Proxy will implement the same command line interface and programming API's where possible, and will note any differences and enhancements/extensions in documentation prepared for mainframe system administrators.

### RACF Commands' Proxy

The Proxy will accept and send to the RAC-AD device for fulfillment (or if more practical for some commands, delegate back the MVS resources) of all 32 currently defined RACF commands and API's. The Proxy could be built to expose a different but similar set of commands, such as those presented by Compute Associates' ACF2 or Top Secret, so as to provide a user (and/or a mainframe system of programs and job control language) familiar with these commands “the same” environment as had been used before. Given the underlying components of this invention and a specification of what the commands are and how they are expected to behave a person skilled in the art could reasonably create such an alternate command library. The RACF commands include:
16 Core database commands (List, Add, Alter and Delete commands to affect database tables: User, Group, General Profile and DASD Profile)
5 Associative commands (CONNECT/REMOVE, PERMIT, RACLINK and RACDCERT)
3 User commands (DISPLAY, SIGNOFF and PASSWORD)
4 Local System commands (HELP, RVARY, SEARCH, SETROPTS)
4 Remote RACF Commands (or optionally omitted) (RESTART, SET, STOP, TARGET)

### Cache Functionality

Cache-aware API's exist for the purpose of dramatic performance improvements that affect the entire mainframe's performance. SAF calls into RACF currently require that RACF implement a handful of cache-aware API's, specifically the RACROUTE functions listed above for Authorization/Access Check, AUTH, FASTAUTH and LIST. These macros use at least one cache per user, plus additional generalized caching. These caches use (are stored in) data areas described in the IBM RACF Data Areas documentation as the ACEE data structure. Currently RACF stores a cache of some of the resource profiles most relevant to the user, and/or (as programmatically directed using the LIST and related commands) a custom cache.

The RAC-AD device will precompute for each RAC-AD user a database “view” of exactly the resources to which this user has access. This is conceptually a list of every access level to every resource that this user can access on the entire mainframe—on a per-user basis. and create a derivative profile that stores only the access level most relevant to this user and most relevant to this resource that takes into account all relevant groups and resource profiles. This precomputation will store an “answer cache” that is more relevant to the actual Access Check questions than the current RACF cache design. This is because RACF may need to perform several computations when Access Checking even ACEE-cached data to eliminate irrelevant security rules for a given Access Check.

### Examples of Use

The following examples may require that the following context and installation steps are already satisfied:
An IBM RACF security system is in use for this example
The RAC-AD device has been installed as DASD on a mainframe
The RACF database has been copied to the RAC-AD device
The RAC-AD proxy and cache have been installed and loaded (as either the external security system, or by inserting code to execute prior to RACF in the SAF exits defined in the RACROUTE Guide¹² ¹²IBM RACROUTE, Appendix C, pp. 379ff.
The RAC-AD device is done with its initialization steps and any further installation configuration

At this point, users may begin to interact with the mainframe and with the RAC-AD system.

### 3. User Enrollment

All users must be enrolled to the RAC-AD system to match their mainframe user ID to their Active Directory User record and GUID. Upon installation, the RAC-AD administrator may provide the RAC-AD device with a list of user identifier pairs so as to batch-enroll users and link their mainframe user ID to their Windows user account. If the RAC-AD administrator has made any mistakes in such a list one of two probable events will occur:
The person-user will not be able to authenticate to the mainframe. This is likely because the administrator connected his or her mainframe user ID to a Windows AD user incorrectly, and the person-user will not be able to supply the correct Windows AD password for that user. (It is possible that the randomly connected Windows AD user will use the same password as the person-user in this example, but that should be made unlikely by Window AD password policies.)
The person-user will be prompted to enroll. This is possible if the RAC-AD administrator mistakenly overlooked this person-user's mainframe login ID in the batch list supplied to the RAC-AD device.

Such a batch enrollment is most convenient but also, due to the possibility of mistakes, less secure than user-initiated enrollment. In the examples below it is assumed that the users were not batch-enrolled to the system.

### Mainframe Paradigm

This narrative maintains the agnosticism that the unenrolled user may or may not be aware of the installation of RAC-AD. The person-user attempts to connection to the mainframe as usual, and receives the familiar prompts for username and password. The system responds with a warning and messages such as these:

WARNING: YOUR MAINFRAME ACCOUNT PASSWORD WILL

NOW BE CONNECTED TO YOUR MICROSOFT WINDOWS
ACCOUNT. FOR QUESTIONS, PLEASE VISIT <url>

PLEASE ENTER YOUR WINDOWS LOGIN ID:
PLEASE ENTER YOUR WINDOWS PASSWORD:
THANK YOU. PLEASE WAIT . . .
THANK YOU. YOUR MAINFRAME PASSWORD IS NOW YOUR

WINDOWS PASSWORD.

Upon successful authentication to the Windows AD domain using the credentials supplied, the mainframe user ID will be cross-linked with the Windows AD User. If the authentication fails the user session will be allowed to carry on as normal and an alert will be produced for the RAC-AD administrator. The user will be prompted at each sign-on to attempt to link again with the same warning and messages listed above. The RAC-AD administrator will receive information in the alert stating which authenticated mainframe user failed to link, what Windows user they attempted to link to, and other diagnostic information. Additional confirmation, error handling, logging and retry logic should be performed by one skilled in the art.

### Windows AD Paradigm

Users may also link their mainframe user ID to their Windows AD User account using a RAC-AD supplied web page. The web page should use HTTPS encryption and require authentication (either Microsoft Internet Information Server-style authentication, or a third party product such as Computer Associates' SiteMinder). The web page should then ask the user to enter his or her mainframe user ID and password, and these mainframe credentials should be verified by the RAC-AD system. Additional confirmation, error handling, logging and retry logic should be performed by one skilled in the art.

### 4. User Sign On

Once enrolled, users may sign on to the mainframe using their Windows AD credentials. They may no longer use their old mainframe credentials, with the exception that their 8 character (or less) mainframe user ID will remain an acceptable (and in some cases preferred) alias for their Window AD enterprise user ID. This is because AD can support user ID's that exceed 8 characters and are therefore not compatible with the RACF requirement of an 8 character maximum. If needed, additional alias mechanisms may be developed by one skilled in the art.

### Mainframe Paradigm

Users who sign on to the mainframe using a terminal or an existing terminal emulator will be prompted for their mainframe login ID and their Windows AD password. The Microsoft User GUID will be used instead of the mainframe user ID when the RAC-AD proxy sends the logon request to the RAC-AD device; this GUID will be stored in the mainframe UUID user field. The RAC-AD device will then initiate a Windows AD logon sequence using the credentials received from the user via the RAC-AD proxy, which will authenticate against the nearest Windows AD domain controller, the RAC-AD device itself. The RAC-AD device will then return the authentication results to the RAC-AD proxy and the mainframe operating system. NOTE: this assumes that the RAC-AD device, since it is mainframe channel-attached, is a trusted device with a trusted communications link to the mainframe. The Windows AD password will be transmitted without encryption within this “trusted” context.

Users with existing mainframe accounts who sign on to the mainframe by way of the RAC-AD device will no longer need to present credentials, unless the RAC-AD device is configured to require this user to re-authenticate at the security administrator's preference. Their AD Kerberos ticket will be requested for the service and will be authenticated according to the Kerberos protocol; once authenticated to the RAC-AD device via Kerberos, RAC-AD will consider that user authenticated to access the mainframe, playing its role as external security manager.

### Windows AD Paradigm

Windows users will likely map drives or otherwise access the RAC-AD device from the TCP/IP Windows network in the same way that they access other domain member servers and domain controller servers. Common uses of such a networked filesystem may be to view reports, to upload/copy batch input files and download/copy batch output files, and to “open” mainframe dataset and resources in other appropriate ways. RAC-AD will allow the Windows operating system to perform its normal Kerberized authentication against such users' requests.

### 5. Resource Authorization/Access Check

Since resource access checks are the most performance-critical function performed by any mainframe security product, this function will be described in detail to illustrate the performance features of RAC-AD.

### Mainframe Paradigm

The following scenario illustrates a cache-hit example.
Mainframe user (bob) requests access to a specific resource (AB.CD.EF)
Mainframe operating system calls SAF with request
SAF requests a RACROUTE REQUEST=AUTH from the installed security manager
SAF security product router table invokes RAC-AD proxy
   RAC-AD proxy identifies User GUID and Resource Name
   RAC-AD proxy performs a hashed lookup of User and Resource against cache; cache hit
   RAC-AD proxy computes access level and any conditional access logic described in the best-match Profile
   RAC-AD proxy compares answer with request and returns ALLOW or DENY
SAF accepts RAC-AD results, and ALLOWS or DENIES user request

The User's Windows groups and Windows GUID are used to pre-compute the answer cache, therefore it is accurate to say that the User's Windows-defined authorizations were used to grant or deny the user's access request. The exact same groups and RACF/RAC-AD profiles are defined on the mainframe for this user—the underlying data source is the same for both the mainframe and the Windows paradigm.

### Windows AD Paradigm

Windows Explorer is used to navigate the files and folders to which the user has mainframe/RAC-AD access based on records in the answer cache for that user, effectively presenting the answer cache in a graphical user interface. User requests an action on the filesystem, which is sent through Windows Kerberized networking to the RAC-AD Windows server, via the Windows operating system, and is processed by the RACFS. RACFS translates the request to a SQL query of the latest answer cache specific to the requested resource to authorize the request. RACFS processes any additional conditional access logic and ALLOWS or DENIES the request. ALLOWED requests are processed by the RAC-AD device and the RACFS.

Here too the User's Windows groups and Windows GUID are used to pre-compute the answer cache, therefore it is accurate to say that the User's Windows-defined authorizations were used to grant or deny the user's access request. Therefore, the same answer cache provides correct answers to security access requests regardless of the request-originating platform or paradigm.

### 6. Common Security Administration

### Mainframe Paradigm

Mainframe security administration will occur using the command line interface and/or using other RACF-defined interfaces in a way compatible with the prior security management system. The design goal for this paradigm is to maintain as much similarity as possible to the mechanics of the prior system. However, the underlying data for Users and Groups will be linked to entities in AD. As a result, mainframe-initiated group membership changes, user information changes, etc. will immediately affect both changes. Both mainframe and Windows administrators will have the capability to alter this User and Group enterprise security data from within their native paradigm.

### Windows AD Paradigm

Similar to the mainframe paradigm, Windows security administrators will be able to alter the enterprise security records related to User and Group, even those that are in current use on the mainframe. All Windows AD management tools may be used natively to update AD. These updates will, upon replication to the RAC-AD device, immediately trigger the re-computation of the answer cache for all affected users and groups; the answer cache will then be updated by the RAC-AD proxy and cache.

All Security changes from the are subject to AD replication delays before they will have enterprise-wide availability.

### Implementation Specific Details of Exemplary Embodiments of the Invention

7. Server Data Model: IBM RACF Authorization translation engine Existing RACF products compute several kinds of “best match” results before allowing a defined and authenticated user to access a requested resource (at a requested access level). The following sequence of processing is characteristic of IBM RACF processing for these “best match” results:
1. Given this user (joe), this resource (A.B.C) and an access request of writing an alteration (ALTER) to an existing dataset,
   a. What is the best matched Profile to govern this request for the specified Resource?
   b. Is this User named for the best-match Profile? At what Access Level?
   c. If not, does this user belong to any of the groups named for this best-match Profile? At what Access Level?
   d. What is the highest Access Level this requesting user may currently obtain (rollup of b and c)
2. Check additional simple constraints, especially related to the best-match profile
3. Respond by authorizing or denying request

This introduces a delay in every user's access request for every resource, every time. In RACF, when the “best match” profile is not cached in main memory, then the delay is significantly lengthened due to the I/O and processing required to find the “best match” Profile.

The following “best method” logical data model is provided for this invention. This data model can be used to compute and store the answers to questions 1.a, 1.b, and 1.c, and then compute and (optionally) store a rollup answer to question 1.d for IBM's RACF. The storage of the answers to question 1.d is not shown on this diagram, but is suggested with the dotted relationship drawn between User and Resource. The data structure associated with such a relationship is described in detail in the section above, “Cache Structure: User view of Resources and Access.”

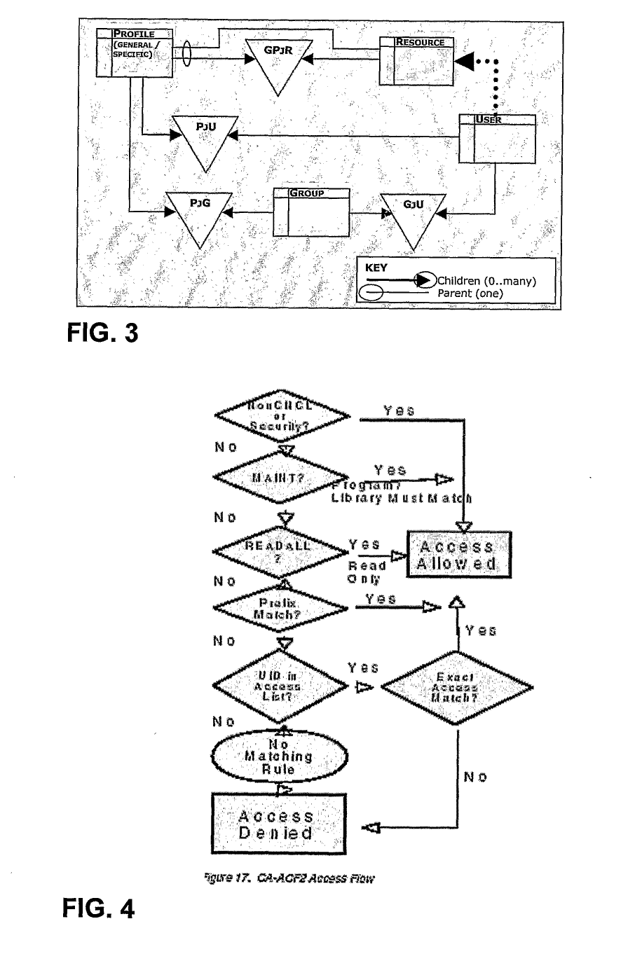

FIG. 3 shows a logical data model that one skilled in the art could interpret, and given documentation of the data fields proper to the colored-rectangle tables, could implement using an off the shelf relational database management tool such as Microsoft SQL Server. Documentation of the data fields used by RACF can be found in IBM's documentation of RACF Data Areas.

The improvement to RACF emphasized in this data model is the introduction of the storage in table format of what are commonly called “junction tables” in data modeling. The junction tables shown are these:
GPjR (General Profile junction Resource)
PjU (Profile junction User)
PjG (Profile junction Group)
GjU (Group junction User)

These four junction tables represent a design choice to prefer to spend computer “space”, in this case disk space for the permanent storage of the junction tables, over the expenditure of processing time. In other words, the junction tables precompute and store values that are expected to be needed later when processing speed is urgent. These factors justify this design improvement:
The low cost of disk space (The cost per gigabyte of disk storage has declined exponentially for several decades since the relevant RACF design was finalized)
The cost advantages of off-mainframe processing (Intel MIPS are cheaper than mainframe MIPS)
The high cost to mainframe throughput of waiting for authorization “answer” computation
The ratio of mainframe authorization requests to security administrator adjustments is a large number and is likely increasing not decreasing

This design anticipates some level of ongoing periodic processing in the RAC-AD device to continue to respond to changes introduced by security administrators. Each change to the tables represented as colored rectangles in the diagram will introduce (in most cases) many changes to the related junction table(s). It is expected that at least one Windows server be dedicated to this ongoing processing task.

Data integrity must be carefully managed. Inserts, updates and deletions to the tables Resource, Profile, User, and Group—and the cascading affects that these should cause in the junction tables—should be protected by SQL transactions. Following such transactions, the “answer cache” should be updated on the proxy. To prevent disruption to ongoing mainframe processing, the RAC-AD proxy should be notified of a pending cache refresh, and the proxy should be allowed the freedom to choose on a per-user basis an optimal time to refresh its cache. The entire (or applicable subset) per-user cache should be capable of being loaded from the RAC-AD device to the proxy in a single I/O request to the device.

The following list describes the tables shown in the diagram more fully. More information regarding the AD view and synchronization activities related to this information is given in the section below titled “Windows IFS file system extension characteristics.”

| Table Name | Description of Contents | Notes (regarding relationships) |
|---|---|---|
| Profile | Union set of all profiles, whether | Profile may have either a foreign |
| | generic (wildcarded) or specifically | key to Resource in the case of a 1:1- |
| | mapped to one resource. | mapped specific profile, or if not, |
| | | then the GPjR junction table will be |
| | | used to map a many-to-many |
| | | relationship (general profiles only). |
| | | Denoted by white oval. |
| Resource | Exhaustive set of all resources | Dotted relationship to User |
| | protected by RACF/RAC-AD. | indicates that an “answer cache” |
| | | could be pre-computed, effectively |
| | | showing each user's authorized |
| | | resources, given the current best- |
| | | match profile and group. |
| User | List of all users defined to | Not shown: 1:1 relationship |
| | RACF/RAC-AD. Once user is | between this User record and the |
| | linked to Windows AD, UUID | corresponding (once linked) record |
| | values will be set appropriate to the | in AD for this user. AD record will |
| | Active Directory and user fields will | be the parent of this via the UUID |
| | be snapshot-merged into AD and | (GUID) foreign key on this User |
| | this user record will become | record. Synchronization between |
| | subservient to the AD record of this | AD and this table will be |
| | user. | maintained. |
| Group | List of all groups defined to | Not shown: 1:1 relationship |
| | RACF/RAC-AD. | between this Group record and the |
| | | corresponding record in AD for this |
| | | group. AD record will be the parent |
| | | of this via the UUID (GUID) |
| | | foreign key on this Group record. |
| | | Synchronization between AD and |
| | | this table will be maintained. |
| General Profile | If a General Profile, then this table | See note for Profile. |
| junction | will contain the set of all of this | |
| Resource | GP's resources, with Resource-best- | |
| | matches (one of these per Resource) | |
| | flagged in the case of IBM RACF. | |
| | (See algorithm description below) | |
| Profile junction | Lists all users authorized explicitly | None. |
| User | (not via groups) by this Profile. In | |
| | the reverse, all profiles where this | |
| | user is explicitly named. | |
| Profile junction | Similar to PjU, except for groups | None. |
| Group | that are named in the profile. | |
| Group junction | All groups this user is a member of. | See notes for User and Group; this |
| User | In the reverse direction, all members | table will have maintained |
| | of a given group. | synchronization for all group |
| | | membership specified by AD for |
| | | the groups and users defined in |
| | | RAC-AD. |

### Variation for Computer Associates' (CA) Top Secret

CA Top Secret uses what IBM calls a different “philosophy” of protecting access that revolves around the user (first) instead of the resource. This is described in the IBM Top Secret to RACF Migration Guide, pages 33-38. In Top Secret as well as in RACF the processing required to determine if a user has access to a given dataset or other resource must be done in proper order, but this order is both configurable and can be more complex compared with RACF. Three options for processing order are laid out in the Migration Guide cited in this paragraph:
1. Override/Allover sequence or mode
   a. For the requesting user, determine the best match user access level as compared against the access rules defined on the requested resource. If no match, continue.
   b. For each of the groups (“profiles”) that the requesting user is a member of, in the order that the group is listed in the user's profile, that group is checked for access. If multiple matches, the most specific match is preferred. If no match, continue
   c. The ALL (users) record is checked for access to the requested resource. If no match, then deny access request.
2. Merge/Allover
   a. The sets of accesses afforded a user directly and by way of group (“profile”) membership are merged, and the merged set is checked for rules that grant access to the desired resource. If multiple matches, the most specific match is preferred. If no match then continue.
   b. The ALL record is checked as in 1.c
3. Merge/Allmerge
   a. As in step 2, the set of user access union the set of all of the user's group (“profile”) accesses is prepared, and this set is merged with the ALL record. This union set of all three described sets is then checked for all rules that grant access to the desired resource. Conclusions are reached as in 2.a.

Top Secret uses several attributes that affect the final determination of the access request but require simple tests as opposed to the matching and merging described above. Implementing any of these (these three options are exclusive systemwide) algorithms as described in more detail and precision in the IBM Migration Guide and as implemented and testable in the CA Top Secret product would be possible for one skilled in the art and given the data model above. In general, a person of normal skill in the art would develop SQL code to be run after row insertion that would compute the match or best match (as is appropriate) following the described methods of RACF, Top Secret or ACF2 (etc.). That SQL programmer would then test to verify that the SQL code produced the same answer cache for a given user and resource(s) as did the RACF, Top Secret or ACF2 system in view. The difference would be the implementation of the RACF, Top Secret or ACF2 algorithm using the data model (above) and SQL code to precompute the user's access level given a specific user (linked by that user at some prior time to its corresponding AD UUID) and specific resource.

### Variation for CA ACF2

Similar to the CA Top Secret external security system, CA ACF2 implements a different sequence in its authorization checking to achieve matches between a user's request for a specific resource and the appropriate authorization rule(s), and the computation of the resulting authorization of that request (either to allow or deny access as requested).

Compared to RACF CA ACF2 has more global “privilege” options that could be used to short circuit what could otherwise be a lengthy computation process. FIG. 4 is similar to a FIG. found in IBM's guide to migrating from ACF2 to RACF, the first three diamond entries in the flowchart (read from top to bottom) represent three or four global access privileges that are not present in RACF. Next, the “Prefix Match?” diamond allows users with the same name as any High Level Qualifier (HLQ—similar to a directory located immediately below a root directory or a drive letter in other operating systems) access any resource below that HLQ. This technique allows a certain level of delegated administration within an HLQ, and could be used similarly to a group that had been created for that purpose. Finally, the “UID in Access List?” diamond indicates processing similar to what RACF performs, although minus the processing related to groups.

In general, ACF2 does not support groups (or arbitrary associations of users in such a way that all members of the group are allowed and denied access the same, against an arbitrary set of resources). Neither does it support the wildcards of *, ** and % that RACF does for its generalized and extended generalized naming by profiles of resources. This simplifies the task of reproducing ACF2-like access control into the data model introduced above for RACF; the Group table and related PjG and GjU tables are not required when simulating ACF2 in the RAC-AD device.

### RjGP: RACF Resource Best Match Algorithm

In order to maintain the existing RACF command line interface and yet maintain the seamless translation to Windows-style directories and permissions it is necessary to maintain a working translation model that accounts for the unique complexities afforded by the generic naming (now obsolete) and the enhanced generic naming features of RACF. Also, the best practices described in this section related to the “most specific” profile also relate to Top Secret's preference for the most specific match.

When precomputing the “answer cache” on the RAC-AD device it is necessary to have an algorithm that determines which of multiple matching profiles is the “best match” for each defined resource. An efficient solution to this problem uses algorithm principles of pre-sorting a list—in fact, ensuring that each addition to the list from an empty list forward maintains a sorted order—in order to find the best match. The following terms are used in this solution:

Containing: Each RACF profile may contain one (perhaps zero) or more resources.

Masking: each “more specific” generic profile masks (or hides) all matching, but less specific, generic profiles for a given data set that matches all generic profiles in question. In other words, the “best match” function makes it so that nearer, more specific generic profiles eclipse all generic profiles that apply but are farther/less specific.

### The RAC-AD Tree

Given these terms, a solution is to build a sorted tree structure where generic profiles serve as containers of all data sets and all more specific and therefore masking generic profiles. Given this tree design, an existing sorted tree algorithm could be identified from a common algorithm source such as Donald Knuth's The Art Of Computer Programming, or from other tree sort algorithm sources. Such a starting-point algorithm would need to be modified as described below.

To implement the tree sorting algorithm with success, a comparison function specific to RACF generic naming and extended generic naming must be developed as follows. Each container in the tree would need to be able to hold a sorted list containing both other containers and leaves, where containers are RACF profiles and leaves are protected resources. The comparison function would need to allow, on insertion to the tree, both containers and leaves to “fall in” to profiles that allowed a match. When the comparison did not indicate “fall in,” then it must either indicate a “stop” when the inserted item had found its proper sorted location within the tree, or “continue” when the inserted item should compare to the next item in the tree and thereby continue self-sorting. Finally, whenever a container sorts into the tree, it must keep track of all resources and containers that it encounters that should “fall in” to it. When such a container either stops and settles in to its proper sorted position within the tree, or falls into a container, it should “pull to itself” those items that should fall in to it. This action by a container will effect the “masking” function of the more specific generic profile in RACF.

In this sorted tree the best match profile (for a resource or leaf) would be the last profile that it had “seen” as it had self-sorted and fallen-in through the tree on its way to settling into its proper place. And all of the containers that it had “fallen in” to would be able to lay claim to that resources as “matches.” Therefore, after the insertion of a new leaf in the tree, the appropriate RjGP records should be inserted—one record for each “fallen into” container, and a flag marking the last “fallen into” container as the best match.

When a container is inserted into the tree and “pulls to itself” some of the leaves and/or other containers, it must update the RjGP table as well as insert a row into Profile. The updates to RjGP should be the following: 1) For each leaf that this inserted container “pulls to itself,” that leaf's “best match” record in RjGP should be changed to indicate this newly inserted container. 2) For each container that this newly inserted container “pulls to itself,” those containers (and recursively, all containers within them) must insert a new record in the RjGP table for each leaf contained in them indicating that the newly inserted container is now also a non-best profile match for that leaf.

These two processes (above) must be implemented in an appropriate way to maintain a correctly sorted tree and RjGP table integrity upon deletion of a leaf or container.

### RjGP Storage Versus Tree Persistence Tradeoff

So long as the tree described above considered as an in-main-memory data structure, then it would seem optional to store in the RAC-AD device all matched but not best-matched rows in RjGP. During periods of time when insertions and deletions happen most frequently, it would be more efficient to refrain from RjGP database row insertion and deletion except for “best match” cases that actually need to affect the computation of updates to some user(s) “answer caches.” Such a temporary bar on extraneous (to the answer caches) insertions etc. would save a lot of processing cycles on the RAC-AD device. However, in the case of an unexpected shutdown of the RAC-AD device the in-memory tree could be lost, and require being rebuilt upon restart which would cause latency in the start-up of the device. Even in this bad case scenario the precomputed and stored answer caches for every RAC-AD defined user would be available even before the tree had been rebuilt; this latency would primarily affect the ability of system administrators and automated tools (such as the Microsoft Identity Information Server, or Role Based Access Control tools, etc.) from effecting their desired changes on the RAC-AD security control points already stored in the device and cache (essentially the answer cache data in use within the RAC-AD proxy). Also, if the RAC-AD database is used for analysis to find redundancies and/or patterns in the profiles that have been created by security administrators then having persisted the complete set of all match and best-match rows in RjGP will be useful.

In conclusion, even though it may be appropriate to cache and batch the updates to non-best-match RjGP records, it is useful to include tree persistence in the design if it can reduce the startup time.

To persist the tree requires the implementation of a recursive table structure surrounding the RjGP and related tables. This can be done by one skilled in the art of data modeling and implementation by adding a foreign key field to generic Profile records that is interpreted as the “parent container,” and then accurately inserting and deleting from the Profile table to maintain the integrity of this data.

### 8. Mainframe Cache Data Structure: User View of Resources and Access Computing the Answer Cache

The answer cache will be computed by a set of SQL SELECT statements against the persisted data stored in the database described above. One answer cache will be computed for each user, upon login to the mainframe. That user's full answer cache, generally speaking, will be the set of all of applicable Best Match Profiles for this user, joined against all of the applicable Resources that this user can access.

User has many:
[ Resource - join - Best Match Profile ]
(the “answer cache” for the user's ACEE)

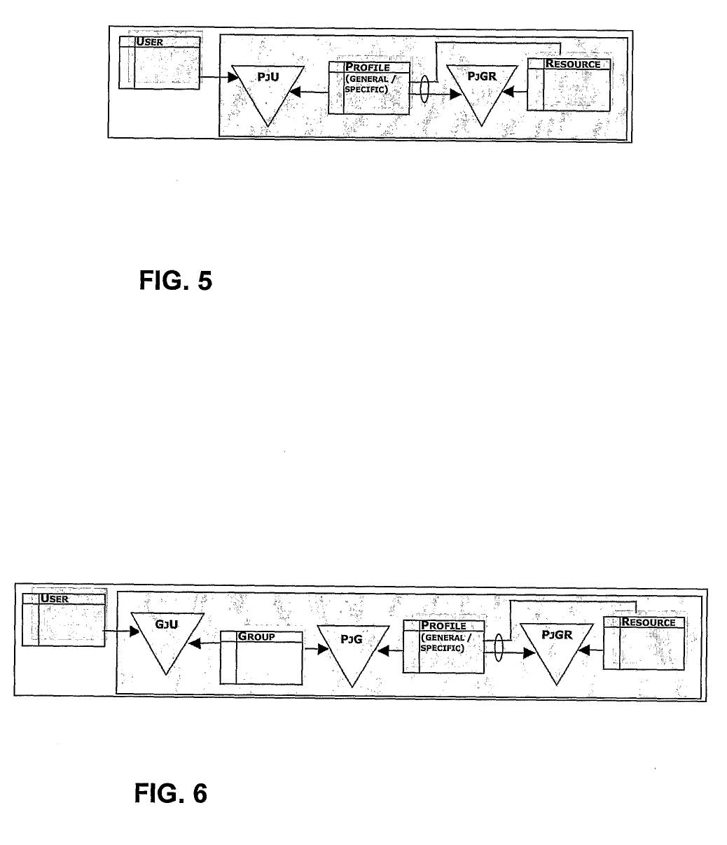

More specifically, two results sets (the union set) from two queries of the database are required to compute the answer cache for each user. The diagrams below indicate the use of one user's unique name or key to generate a results set from the tables in the gray boxes. The actual results sets can optionally include any fields from the junction tables, and can optionally include any fields from the Resource table (for example fields used for filtering the answer cache). The relational database join logic required to create the correct results set is shown in FIG. 5. A query can be made to provide Simple User Access Grants (Groups not considered)

FIG. 5 indicates that the key for the User table can be used to select all related rows on PjU (a join). Each PjU row will then be joined to its parent-related record in Profile, be that row a specific or a generic profile. In the case of a specific profile, the next join will be directly to Resource—this should be coded as an outer join so that if there is no match to Resource the query continues unaffected to process the Profile as a generic profile record. So, if the Profile is a generic profile it should find all children-related rows on PjGR, and from those PjGR rows, join to find the Resource associated with them.

The second query is similar, but does not deal with user grants (also known as grants to “members”) but with grants made to groups as shown in FIG. 6. In this case, the query is for Group Access Grants (Members not considered)

FIG. 6 indicates much of the same processing and query logic as in diagram 1 with these exceptions: Initially, the user key will be used to find all of the user's group memberships from the GjU table (potentially this could be replaced by a lookup to the user's current Active Directory group membership as an optimization as discussed elsewhere in this paper). One the user's group memberships are selected, join to the parent Group records and then select all related PjG records to obtain profile inclusion for all of the groups that this user is a member of. From this point the query logic is the same as in Query 1 (FIG. 5), noting this small difference: in Query 1 (FIG. 5) the parent Profile records are obtained on a join from PjU, but in Query 2 (FIG. 6) the parent Profile records will be obtained on a join from PjG.

For both queries FIGS. 5 and 6 show that both specific profiles and generic profiles are to be selected in the same query; if this is not supported by the relational database, then both queries must be broken into two component pieces and the results sets of all four queries must be concatenated (union operation) together. Both queries should use the same list of fields in their results set, even though Query 2 (FIG. 6) will select group name and that field is not applicable to Query 1. If a field is not applicable to a query, simply select a NULL or system-specific empty value into that column.

To complete the processing tasks of the creation of the answer set, the union set of queries 1 and 2 must be reduced to eliminate all multiple rows for the same resource, except where warranted by the presence of special conditions that cannot be resolved at the time of the selection. Examples could include access restrictions made to users based on the terminal in use at the time of the request, or restrictions based on the time of day of the access. However, both of these examples could also be resolved entirely by the RAC-AD device using these optional techniques and given the fact that the RAC-AD answer cache is first computed upon successful user authentication/sign on to the RAC-AD device:
The terminal in use by a user for a given session does not change after logon. Therefore, the user's current terminal identifier could be passed as well as the user's UUID to the RAC-AD device and used to create a user- and terminal-specific answer cache
The time of day is known at logon, and based on the union set of queries 1 and 2 the next (upcoming) significant time, that is the next qualifying time embedded in the conditional access rule, could be used to set a “run at” function on the RAC-AD device. The “Run at” function is common operating system feature used to execute a command at a particular time of day, week, month, year, etc. The command could be programmed to select a new answer cache and signal the RAC-AD proxy to reload the new answer cache (or cache changes relevant to the time change, see “Using Parts of the Answer Cache” below).

### Using the Answer Cache Fields in ACEE

The RAC-AD proxy and cache should not make a hard and fast assumption that the RAC-AD device will always be able to precompute the answer cache to the point that a Resource will certainly have a maximum of one row in the cache. It may be that it will be most efficient or effective to defer some level of conditional processing to the mainframe, allowing the mainframe to make the ultimate access determination. However, the majority of the computation is expected be done by the RAC-AD device.

The RAC-AD proxy and cache will request and receive the answer cache upon the user's first access request, likely immediately after the user logs in. The answer cache (or selected rows of it, see “Using Parts of the Answer Cache”) will be loaded into main memory on the mainframe by the RAC-AD proxy and cache. At this time the RAC-AD proxy and cache will issue an I/O command to the RAC-AD device as a dataset request, then copy data from the RAC-AD's DASD upon receiving this I/O to the mainframe and set the data into the mainframe's main memory following the IBM or external security product data layouts. This will occur on a per-user basis at sign on and upon cache reload commands issued by the RAC-AD device or manual intervention (automatic cache reload commands will be issued via SNA conversation by the RAC-AD device). The RAC-AD proxy will follow a naming convention when reading the answer cache, for example:
RACAD.TOCACHE.ANSWERS.<USERID>

In the naming convention above, <USERID> is the mainframe user ID that uniquely identifies this user. This dataset for performance reasons may not be actually stored on disk before it is returned by the RAC-AD device to the RAC-AD proxy and cache.

The list of fields received by the RAC-AD proxy in the answer cache depends on the mainframe security product in use before RAC-AD's installation, because that product will determine the compatibility expectations for RAC-AD. Generally speaking, the correct field list is obtained by selecting all of the fields from the Profile table, as this should match to the complete list of fields that can be altered by a security administrator using the RACF (or external security product) command line interface and the list of fields documented by the product vendor as affecting the outcome of the access request. While these lists of fields vary between products, this task of identifying relevant fields is a matter of inspection and can be performed by one skilled in the art. The product-specific field lists can be determined concretely when this design is reduced to practice for each mainframe security product.

### Using Parts of the Answer Cache

Some parts of the answer cache will be more likely to be used. Other parts of the answer cache may be predictably likely to be used at certain times or by certain processing sequences. The full answer cache will be filterable to produce a reduced-size subset by any field defined on Resource; it is anticipated that some installation-specific fields will be allowed on this table. This is important in cases where the full answer cache is too large to be reasonably stored in main memory in that user's ACEE. The decision to omit some entries from the cache should be configurable to as large an extent as practical since there is an element chance surrounding the possibility of disappointing users' performance expectations by cache misses caused by decisions to omit some entries from the cache. In other words, mainframe users likely have the best understanding of which parts of the precomputed full answer cache to omit from the actual mainframe cache; RAC-AD documentation and user interfaces should promote its users' capability and understanding of how to control this selection of omitted parts as much as possible.

### Preference for “Answer Cache” Over RACF-Style Cache

In comparison to RAC-AD, RACF does not precompute, store or expose the “best match” profile for a given resource. RACF does provide a programmatic way of requesting processing to determine the best match for a given resource as of the moment of the request. However, caveat emptor, RACF leaves the responsibility of making sure that the answer given a moment ago is still accurate in the hands of the ACEE programmer or AUTH-LIST programmer. RAC-AD ensures that both the RAC-AD cache and the live tree (the answer set and the underlying reasons for the answers, respectively) remain “living,” i.e., accurate to the latest commands issued by security administrators from either the RACF/mainframe command line interface, or the Windows filesystem/Kerberos paradigms. For the RAC-AD system to take on this responsibility makes unnecessary all other cache-employing measures common on the mainframe—the use of AUTH-LIST or custom-programmed ACEE caches. However, for compatibility with these prior methods, the RAC-AD system will support these interfaces specified in the RACROUTE macro API documentation. Wherever possible within the constraints of the existing IBM API the data provided to these programmatic interfaces will contain an answer cache, which is a reduced number of rows of data containing only certain “hits”. However, the answer cache provided by RAC-AD without these programmatic interventions intended to improve RACF throughput performance will more effectively utilize main memory cache and mainframe processing cycles. Thus, wherever possible while still ensuring maximum compatibility with existing mainframe software, programmatic requests to pre-fill the ACEE cache using the unnecessary RACF methods will be ignored and more efficient caching will be employed instead.

### 9. Windows IFS File System Extension Characteristics

| | Mainframe | Windows Command | Windows Explorer |
|---|---|---|---|
| Line | Dataset | Line view | Tree view |
| 1 | AB.CD | C:\AB\CD (folder) | [symbol] |
| 2 | AB.CD.E | C:\AB\CD\E (folder) | |
| 3 | AB.CD.EF | C:\AB\CD\EF (file) | |
| 4 | AB.CD.EFG | C:\AB\CD\EFG (file) | |
| 5 | AB.CD.E.HIJ | C:\AB\CD\E\HIJ (file) | |

The Windows user-view of resources should be created by applying the restrictions found in the answer cache for a given user/viewer to the filesystem folder hierarchy described above.

### Windows-Side Translation Effects and Limitations

It may not be possible to maintain a perfect translation between mainframe RACF (and other mainframe external security products) and Windows NTFS and related components; some losses and additions will occur due especially to the differences in the algorithms, approaches and “philosophies” between these systems. The following translation priorities, in order, will be honored by RAC-AD:
1. The same security answer will be given for the same resource authorization request by the same user, whether the access request is made from the mainframe or the Windows paradigm.
2. The same usage (command line interface or Windows-based graphical or command line interface, etc.) will be presented to the security administrator as existed before the introduction of RAC-AD
3. Users, Groups and Resources will be unique across both paradigms, and the data associated with each of these entities will be the same. Wherever possible, the data associated with these entities will be available to be read, updated, etc. from both paradigms, as supported by those paradigms' interfaces to RAC-AD.
4. The translation of Profiles, and their best-matches with Resources, to Windows filesystem elements and their assigned DACL's will prefer the mainframe paradigm and will appear to Windows as a filesystem of type RACFS.

The following table provides a translation of terms from RACF to Windows (Microsoft AD or NTFS):

| RACF Term | Windows Term | Notes and Caveats |
|---|---|---|
| User | User, also a | Data structure containing a unique key and several other |
| | Kerberos Principal | fields related to this user. Often the term “user” is a |
| | | nickname for the unique key for this user (not the data |
| | | structure), which is an 8 character EBCDIC string in |
| | | RACF and is, for our purposes, the Microsoft AD |
| | | Domain GUID. Users are often intuitively thought of as |
| | | corresponding 1:1 with people (by name), but there are |
| | | common exceptions such as secondary logins and system |
| | | accounts. As used here, the terms “login” or “login/logon |
| | | ID” are nicknames that refer more strictly to the unique |
| | | key to the User that is formatted as a short string of |
| | | characters that people use when entering their logon ID |
| | | for authentication. |
| Group | Group, also a | See note for User; the correspondence with people is even |
| | Kerberos Principal | more loose with Groups. |
| Profile | DACL (or just | Both include some data structure including these four |
| | ACL for short) | main parts: |
| | | the access, level of privilege, or permission(s) |
| | | that this data structure confers; |
| | | the list of users allowed this access; |
| | | the list of groups allowed this access; |
| | | special conditions affecting the grant or denial of |
| | | this access. |
| | | Dissimilar because a RACF Profile also includes a |
| | | specific or a generic name that is used to “match” the |
| | | profile to resources at runtime, but are stored |
| | | independently of any existing resources. Windows |
| | | DACL's are stored as attributes of each filesystem |
| | | element, such that no “matching” is performed at runtime. |
| | | Instead, Windows uses what is called inheritance to |
| | | assign DACL's to filesystem elements. Runtime checks |
| | | are performed by the operating system to merge together |
| | | all DACL's in the full filesystem path to the resource. |
| Resource | Filesystem element | As noted above, the RACF resource name compares |
| | (file or folder) | closely with the fully pathed name of a filesystem |
| | | element, provided that “.” RACF delimiters are converted |
| | | to “\” Windows delimiters, and the translation goes from |
| | | RACF to Windows since Windows has less restrictive |
| | | element naming rules. |
| Generic | Windows NT | Similarities include: Allows security administrators to |
| Naming + | static inheritance | secure multiple files/datasets by (re)using the same |
| “Best Match” | | Profile/DACL to secure all “children” or “matches”. |
| - or - | | Both mechanisms allow a “more specific” or “lower” |
| Enhanced | | Profile/DACL to override. Dissimilar in that wildcards |
| Generic | | are not allowed as a prefix or anywhere in an HLQ by |
| Naming + | | RACF, and RACF allows “asterisk in the middle” generic |
| “Best Match” | | names (i.e., AB.*.CD in generic naming, also AB.**.CD |
| | | recursive wildcarding hi enhanced generic naming) that |
| | | do not have an equivalent in Windows. |
| | Windows 2000+ | Difficult to map exactly because both can be thought of to |
| | dynamic | refer to resources that do not yet exist, but that could exist |
| | inheritance | in their respective namespaces. RACF promotes profile |
| | | updates rather than the introduction of new, competing |
| | | profiles by its strict “best match” policy. Windows |
| | | supports a seemingly unlimited competition between |
| | | DACL's. |
| | Windows 2000+ | Windows 2000 and later supports lists of excluded users |
| | exclusion lists | and excluded groups such that any match between the |
| | | access requestor and one of these exclusion lists results in |
| | | an overriding denial of the access request. This NTFS |
| | | inheritance amounts to the annulment of the “best match” |
| | | approach used by RACF, and instead NTFS uses a much |
| | | more complex Resulting Set of Privileges (RSoP) |
| | | operation to determine access. |

In general, this translation prefers to limit the security administration functions that the RACFS supports to those supported by the RACF paradigm. This limitation will be enforced on the mainframe simply by implementing the RACF command line interface and related commands. This limitation will be enforced on Windows by advertising the RACFS filesystem to the operating system as a restricted-functionality filesystem in cases where it does not support Windows-only features like long filenames and DACL inheritance. Where RACF and other external security systems like Top Secret and ACF2 support “special conditions” that affect the grant or denial of access requests, these additional attributes of the profile will be exposed as new attributes to the DACL or filesystem elements or filesystem as appropriate. In both cases, these feature constraints and feature extensions relative to the Windows paradigm will be expressed as custom Properties dialogue windows and corresponding API extensions for Windows “consumers” of the RACFS. Also, a command line interface must be created to exercise the RACFS feature set in order to complete the translation to the Windows paradigm.

GjU Synchronization with Active Directory

An organization that implements RAC-AD for the purpose of quitting the assumption of local security described herein should begin a purposeful migration towards a unified, enterprise set of groups and away from the mainframe-local and Windows-local groups. At first the RAC-AD Groups table will be loaded entirely with entries that have no overlap with the pre-existing Windows groups. Then, for each non RACF-created Windows group relationship that is added to a profile, that “Windows” group should be added to the RAC-AD Group table.

Eventually the synchronization described for GjU will become burdensome and the GjU table should be obsoleted in favor of reading the list of group memberships directly from AD for each user upon login, and using that “fresh list” to refresh the entire RAC-AD database for that user, recomputing the “answer cache” and then providing that to the mainframe's ACEE for the user. The RAC-AD product should support end-user selection of the GjU-AD synchronization option that is best.

### The Live RAC-AD Profile Tree is Authoritative Over Persisted Replicas

Persisting the RAC-AD Profile tree in the database, as rows in tables, may have an unwanted side effect of increasing the complexity of the presentation mechanism used to make the RAC-AD filesystem compliant and visible to the Windows operating system family. This side effect should be avoided by rejecting the concept that the authoritative source of the filesystem presentation (for example, the Windows Explorer graphical presentation, or the Windows Commands such as “DIR”) is expected to be a persistent store. Instead, conceptually, the RAC-AD device will acknowledge the most authoritative source of security and structural information about the filesystem to be the “live,” in-memory tree and not a persisted relic of it (although the standard practices of virtual memory may briefly write some parts of the tree or its working program to disk, for the purposes of this discussion all virtual memory will be considered to be “in memory” and not “persisted”). This “live tree” will be available to present the RAC-AD data as a Windows filesystem only when the tree is fully started up (despite the potential latency discussed above in the persistence section). This preference of the live tree goes hand in hand with the decision to cache and batch the persistence of non-best-match RjGP rows; the live tree is always current in showing both the best-match RjGP rows and the non-best-match rows, while at the same time it reaps the performance benefits associated with in-memory operations for the insertion and deletion of generic profiles. This design choice is opposite of the preference of persisted authoritative sources in RACF and other security system implementations.

As a result of this design choice, the in-memory tree should utilize what are commonly thought of as object-oriented best practices, including: encapsulating the underlying RACF profile data fields, maintaining a clear distinction between public methods that can provide valuable services to others and private methods and data that hide as much complexity as possible, etc. In general, the tree and its objects should provide security administrative services and views to resource owners and security administrators when these principals have requested alterations to the existing security controls within the scope of the RAC-AD system. Such security administrative services must actually fulfill the RACF command line directives delegated to the RAC-AD device from the RAC-AD proxy. Similarly, the same tree will expose an API suited to the Windows paradigm, for example, allowing owners and qualified users to alter security ACL's using the Properties dialog to affect a file or directory. The technology to create extensions to the Microsoft filesystem, and to create new filesystem types, is available under license from Microsoft and can be implemented by a programmer skilled in the art.

The authoritative, in-memory tree provides an omniscient view of security rules, not a user-view of resources. It should be used to quickly and efficiently respond to changes made by security administrators, and increasingly, rule-based systems that assist security administrators. The tree should carefully restrict and control access to itself, responding only to resource owners and security administrators—and then, only when these are operating within their assigned scope and privilege. The tree should translate special security administrative designations from RACF and create equivalent, well-named and documented (that is, use not only the RACF data set name but also indicate that this is a mainframe resource and what class of resource it is; also, document the meaning of the high-level qualifier) Windows group names.

1-36. (canceled)

37. A method of performing system authorization decisions for a mainframe computer, the method comprising:
generating access information for the mainframe computer at one or more server computers external to the mainframe computer, the access information being indicative of mainframe authorization decisions for a set of users, wherein generating the access information comprises pre-computing the access information for each of the set of users, wherein the access information for each of the set of users indicates whether a respective one of the set of users has access to each of a plurality of resources of the mainframe computer;
receiving from the mainframe computer information indicative of an authorization request, the information indicative of the authorization request identifying a user trying to access the mainframe computer, wherein the mainframe computer communicates the information indicative of the authorization request to the one or more server computers via a proxy executing on the mainframe computer; and
sending at least a portion of the access information from the one or more server computers to the proxy executing on the mainframe computer, the portion of the access information including mainframe access information for the user trying to access the mainframe computer.

38. The method of claim 37, wherein the one or more server computers external to the mainframe computer include a Microsoft Windows server including access control lists (ACL's), wherein the set of users comprises mainframe users defined within the one or more servers as a subset of server users and wherein the plurality of resources of the mainframe computer is a defined within the one or more servers as subset of a set of server resources.

39. The method of claim 37, wherein the information indicative of the authorization request includes an authenticated user identifier (ID) identifying the user, and a resource ID identifying a resource of the mainframe computer that the user is trying to access and an indication of an access type or an access level the user has requested for the resource of the mainframe computer that the user is trying to access.

40. The method of claim 37, wherein the mainframe computer comprises an International Business Machines (IBM) mainframe computing system, and wherein the resource of the mainframe computer that the user is trying to access comprises one of a file, a folder, a transaction, a database element, a database table or a resource that is secured by operation of an IBM System Authorization Facility in conjunction with any participating external security manager product operating in the mainframe computer.

41. The method of claim 37, further comprising, prior to receiving the information indicative of the authorization request:
receiving from the proxy executing on the mainframe computer information indicative of an authentication request, the information indicative of an authentication request identifying the user and including an authentication element associated with the user;
comparing the authentication element to a stored element associated with the user; and
sending an indication to the proxy executing on the mainframe computer of whether or not the user is authenticated based on the comparison.

42. The method of claim 41, wherein the authentication element comprises one or more of:
a password or secret known by the user,
information indicative of a biological characteristic of the user, and
information that provides assurance that the user has within his or her possession an authorized list, cryptographic key, fob, token or proof of trust.

43. The method of claim 37, further comprising sending an indication to the mainframe computer that a portion of access information is expired to prompt the mainframe computer to request updated access information for the user.

44. The method of claim 37, further comprising:
receiving input from a server administrator, the input modifying at least some user privileges associated with the set of users with respect to the mainframe computer;
re-generating the access information stored in the one or more server computers; and
sending an indication to the mainframe computer that access information has changed to prompt the mainframe computer to request updated access information for the user.

45. The method of claim 37, wherein the one or more server computers external to the mainframe computer are connected to the mainframe computer using a mainframe hardware device communications channel.

46. The method of claim 37, further comprising:
receiving input from a mainframe administrator, the input modifying at least some user privileges associated with the set of users with respect to the mainframe computer;
sending the input to the one or more server computers;
re-generating the access information stored in the one or more server computers; and
sending an indication to the mainframe computer that access information has changed to prompt the mainframe computer to request updated access information for the user.

47. The method of claim 37, further comprising:
protecting the access information against a possibility of concurrent mainframe and server update by using a coherency guard function executing within a file system under control of the one or more server computers.

48. The method of claim 37, further comprising returning an authorization decision to the mainframe computer from the proxy executing on the mainframe computer.

49. A system comprising:
a mainframe computer including a proxy executing on the mainframe computer; and
one or more server computers external to the mainframe computer that define security access to the mainframe computer,
wherein the one or more server computers:
generate access information for the mainframe computer, the access information being indicative of mainframe authorization for a set of users, wherein generating the access information comprises pre-computing the access information for each of the set of users, wherein the access information for each of the set of users indicates whether a respective one of the users has access to each of a plurality of resources of the mainframe computer;
receive from the mainframe computer information indicative of an authorization request, the information indicative of the authorization request identifying a user trying to access the mainframe computer, wherein the mainframe computer communicates the information indicative of the authorization request to the one or more server computers via the proxy executing on the mainframe computer; and
send at least a portion of the access information to the proxy executing on the mainframe computer, the portion of the access information including mainframe access information for the user trying to access the mainframe computer,
wherein the mainframe computer:
generates the authorization request, the authorization request identifying the user trying to access the mainframe computer;
sends information indicative of the authentication request to the one or more server computers; and
receives from the one or more server computers at least a subset of the access information, the subset of access information including the mainframe access information for the user trying to access the mainframe computer, and
wherein the proxy executing on the mainframe computer returns an authorization decision to the mainframe computer.

50. The system of claim 49, wherein the one or more server computers external to the mainframe computer include a Microsoft Windows server including access control lists (ACL's), wherein the set of users comprises mainframe users defined within the one or more servers as a subset of server users and wherein the plurality of resources of the mainframe computer is a defined within the one or more servers as subset of a set of server resources.

51. The system of claim 49, wherein the information indicative of the authorization request includes an authenticated user identifier (ID) identifying the user, and a resource ID identifying a resource of the mainframe computer that the user is trying to access and an indication of an access type or an access level the user has requested for the resource of the mainframe computer that the user is trying to access.

52. The system of claim 49, wherein the mainframe computer comprises an International Business Machines (IBM) mainframe computing system, and wherein the resource of the mainframe computer that the user is trying to access comprises one of a file, a folder, a transaction, a database element, a database table or a resource that is secured by operation of an IBM System Authorization Facility in conjunction with any participating external security manager product operating in the mainframe computer.

53. The system of claim 49, wherein the one or more servers, prior to receiving the information indicative of the authorization request:
receive from the proxy executing on the mainframe computer information indicative of an authentication request, the information indicative of an authentication request identifying the user and including an authentication element associated with the user;
compare the authentication element to a stored element associated with the user; and
send an indication to the proxy executing on the mainframe computer of whether or not the user is authenticated based on the comparison.

54. The system of claim 53, wherein the authentication element comprises one or more of:
a password or secret known by the user,
information indicative of a biological characteristic of the user, and
information that provides assurance that the user has within his or her possession an authorized list, cryptographic key, fob, token or proof of trust.

55. The system of claim 49, wherein the one or more server computers send an indication to the mainframe computer that a portion of access information is expired to prompt the mainframe computer to request updated access information for the user.

56. The system of claim 49, wherein the one or more server computers:
receive input from a server administrator, the input modifying at least some user privileges associated with the set of users with respect to the mainframe computer;
re-generate the access information stored in the one or more server computers; and
send an indication to the mainframe computer that access information has changed to prompt the mainframe computer to request updated access information for the user.

57. The system of claim 49, wherein the one or more server computer external to the mainframe computer are connected to the mainframe computer using a mainframe hardware device communications channel.

58. The system of claim 49, wherein the mainframe computer:
receives input from a mainframe administrator, the input modifying at least some user privileges associated with the set of users with respect to the mainframe computer; and
sends the input to the one or more servers computers,
wherein the one or more server computers:
re-generate the access information stored in the one or more server computers; and
send an indication to the mainframe computer that access information has changed to prompt the mainframe computer to request updated access information for the user.

59. The system of claim 49, wherein the system protects the access information against a possibility of concurrent mainframe and server update by using a coherency guard function executing within a file system under control of the one or more server computers.

60. A computer readable medium comprising instructions that when executed in one or more server computers cause the one or more server computers to perform authorization decisions for a mainframe computer, wherein the instructions cause the one or more server computers to:
generate access information for the mainframe computer, the access information being indicative of mainframe authorization decisions for a set of users, wherein generating the access information comprises pre-computing the access information for each of the set of users, wherein the access information for each of the set of users indicates whether a respective one of the set of users has access to each of a plurality of resources of the mainframe computer; and
upon receiving from the mainframe computer information indicative of an authorization request, the information indicative of the authorization request identifying a user trying to access the mainframe computer, wherein the mainframe computer communicates the information indicative of the authorization request to the one or more server computers via a proxy executing on the mainframe computer, the instructions cause the one or more server computers to:
send at least a portion of the access information to the proxy executing on the mainframe computer, the portion of the access information including mainframe access information for the user trying to access the mainframe computer.

61. A server computer configured to perform authorization decisions for a mainframe computer, the server computer being configured to:
generate access information for the mainframe computer, the access information being indicative of mainframe authorization decisions for a set of users, wherein generating the access information comprises pre-computing the access information for each of the set of users, wherein the access information for each of the set of users indicates whether a respective one of the set of users has access to each of a plurality of resources of the mainframe computer;
receive from the mainframe computer information indicative of an authorization request, the information indicative of the authorization request identifying a user trying to access the mainframe computer, wherein the mainframe computer communicates the information indicative of the authorization request to the server computer via a proxy executing on the mainframe computer; and
send at least a portion of the access information to the proxy executing on the mainframe computer, the portion of the access information including mainframe access information for the user trying to access the mainframe computer.
